(19) United States
(12) Patent Application Publication
(10) Pub. No.: US 2018/0018734 A1
(43) Pub. Date: Jan. 18, 2018

(54) METHOD AND SYSTEM FOR AUTOMATICALLY CATEGORIZING FINANCIAL TRANSACTION DATA

(71) Applicant: Intuit Inc., Mountain View, CA (US)

(72) Inventors: Ngoc Nhung Ho, Sunnyvale, CA (US); Meng Chen, San Jose, CA (US); Lei Pei, Sunnyvale, CA (US)

(73) Assignee: Intuit Inc., Mountain View, CA (US)

(21) Appl. No.: 15/213,096

(22) Filed: Jul. 18, 2016

(51) Int. Cl. G06Q 40/06

(52) U.S. Cl. CPC G06Q 40/06

(57) ABSTRACT

Financial transaction data representing a current financial transaction is processed and divided into financial transaction data segments of one of more words or symbols. A financial transaction data segment in the current financial transaction is assigned a financial transaction data segment score based on an analysis of historical financial transaction categorizations of historical financial transactions containing the same financial transaction data segment. The calculated financial transaction data segment score is then compared with a defined threshold financial transaction data segment score and, if the calculated financial transaction data segment score is greater than the threshold financial transaction data segment score, the financial transaction containing the financial transaction data segment is categorized, at least temporarily, as being a first financial transaction category financial transaction.

### BACKGROUND

Currently, several types of financial management systems are available to help an individual user obtain the user's financial data, process/analyze the user's financial data, and/or generate various customized financial reports and displays for the user.

Herein, a financial management system can be, but is not limited to, any data management system that gathers data associated with an individual, business, or other entity, including financial transactional data, from one or more sources, such as financial accounts and financial institutions, and/or has the capability to analyze and categorize at least part of the financial data. One specific illustrative example of financial management systems are small business financial management systems used by small businesses and/or self-employed users to track business related transactions and identify business related transactions that have associated tax ramifications.

One important feature of any financial management system is the ability to categorize financial transactions into one or more financial transaction categories. As a specific example, a financial management system designed to help a self-employed user track their expenses, prepare their taxes, and/or manage their income needs to be able to categorize financial transaction data representing various financial transactions conducted by, or on behalf of the user, as either business expenses, e.g., those in Form 1040 schedule C categories, or personal expenses.

It is also a fact that the more automated this categorization process is, i.e., the less a user has to manually enter classification data, the more likely the user is to gain the most benefit from the financial management system and, not surprisingly, the more likely the user is to continue to utilize the financial management system.

In addition, as a specific illustrative example, it has been determined that in the case of small business and/or self-employed focused financial management systems, the more transactions that are tentatively categorized, reasonably, as business expense transactions, the more the user will value the financial management system and, again not surprisingly, continue to use the financial management system.

However, the accurate automatic categorization of financial transaction data continues to be a non-trivial, and long standing, problem. This long standing problem in the technical fields of financial management, financial transaction data management and processing, and user experience has at least four significant undesirable results. First many users simply stop using the financial management system because the process is too data entry intensive and burdensome to many users who do not know how to, or do not want to, devote the time and energy required, to manually or semi-manually provide the information/data required to accurately categorize financial transactions represented by the financial transaction data.

Second, using currently available financial management systems, in order to modify or otherwise enter data associated with specific financial transactions such as categorization data, the user must often interact with multiple screens and enter data through a keyboard, or other input device, that is often burdensome and difficult to use. In addition, in a world rapidly becoming dominated by mobile systems, such as smart-phones, having to scroll through and interact with large amounts data and categorizations to determine a user's recent spending history and tax ramifications is not only burdensome, but is actually prone to erroneous data entry and analysis. This is because while a “qwerty” keyboard can be made to fit in a space less than 2″ wide, that doesn't make it easy or efficient to use.

Third, currently available financial management systems often employ a hundred or more financial transaction categories, often defined by other parties, such as the IRS, and therefore users lose track of which financial transactions to select and what categories to apply, in the “haystack” of potentially hundreds of financial transaction categories that the user did not define.

Finally, currently available financial management systems often fail to effectively and efficiently leverage financial transaction categorization data from other parties for the benefit of a current user.

As noted above, the long standing need to provide the accurate automatic categorization of financial transaction data is largely unmet using currently available financial management systems. Therefore, avoiding manual and/or inaccurate automatic categorization of financial transaction data is a long standing technical problem in the technical arts of financial transaction data management and processing and user experience. Consequently, both users and providers of financial management systems are detrimentally affected by the current situation.

What is needed is an efficient, effective, and dynamically adaptable technical solution to the long standing technical problem in the financial transaction data management, data processing, and user experience arts of providing accurate categorization of financial transaction data that is relatively simple, leverages financial transaction categorization data from other parties, is largely automatic, and is accurate without being overly burdensome on the user, the financial management system, and/or data processing systems.

### SUMMARY

Embodiments of the present disclosure address some of the shortcomings associated with prior art financial management systems.

In one embodiment, at least one financial transaction category, i.e., a first financial transaction category, is defined.

In one embodiment, financial transaction data representing a current financial transaction is processed and divided into financial transaction data segments of one of more words or symbols.

In one embodiment, a financial transaction data segment in the current financial transaction is assigned a financial transaction data segment score based on an analysis of historical financial transaction categorizations of historical financial transactions containing the same financial transaction data segment.

In one embodiment, the calculated financial transaction data segment score is compared with a defined threshold financial transaction data segment score and if the calculated financial transaction data segment score is greater than the threshold financial transaction data segment score, the financial transaction containing the financial transaction data segment is categorized, at least temporarily, as being a first financial transaction category financial transaction.

Consequently, in one embodiment, the calculated financial transaction data segment score is used to determine the likelihood of the current financial transaction being assigned a first financial transaction category, such as a business and/or tax related financial transaction category, based on an analysis of historical financial transaction categorizations of historical financial transactions containing the same financial transaction data segment and a defined threshold financial transaction data segment score.

Therefore, the embodiments discussed herein represent an efficient, effective, and dynamically adaptable technical solution to the long standing technical problem in the financial transaction data management, data processing, and user experience arts of providing accurate categorization of financial transaction data that is relatively simple, leverages financial transaction categorization data from other parties, is largely automatic, and is accurate without being overly burdensome on the user, the financial management system, and/or data processing systems.

In accordance with one embodiment, a method for automatically categorizing financial transaction data includes defining first and second financial transaction categories.

In accordance with one embodiment, a threshold financial transaction data segment score is defined. In one embodiment, the threshold financial transaction data segment score is defined such that financial transaction data including a financial transaction data segment having a financial transaction data segment score greater than the defined threshold financial transaction data segment score is identified as potential first financial transaction category financial transaction data. In one embodiment, threshold financial transaction data segment score data is generated representing the defined threshold financial transaction data segment score.

In accordance with one embodiment, historical financial transaction data is obtained. In one embodiment, the historical financial transaction data represents historical financial transactions conducted by one or more parties. In one embodiment, the historical financial transaction data includes historical financial transaction categorization data indicating a financial transaction category assigned to the historical financial transactions represented in the historical financial transaction data.

In accordance with one embodiment, the historical financial transaction data is processed to generate historical financial transaction data segment data. In one embodiment, the historical financial transaction data segment data represents identified historical financial transaction data segments.

In accordance with one embodiment, for at least one identified historical financial transaction data segment represented by historical financial transaction data segment data, the historical financial transaction data segment data representing that historical financial transaction data segment is correlated to historical financial transaction category data representing the historical financial transaction category assigned to the historical financial transaction represented in the historical financial transaction data including the historical financial transaction data segment. In this way, correlated historical financial transaction data segment data and historical financial transaction category data is generated.

In accordance with one embodiment, current financial transaction data representing a financial transaction associated with a user is obtained and normalized to generate normalized current financial transaction data.

In accordance with one embodiment, the normalized current financial transaction data is processed to generate current financial transaction data segment data. In one embodiment, the current financial transaction data segment data represents the identified current financial transaction data segments.

In accordance with one embodiment, for at least one identified current financial transaction data segment represented by current financial transaction data segment data, the correlated historical financial transaction data segment data and historical financial transaction category data for that current financial transaction data segment is obtained and analyzed to determine a current financial transaction data segment score. In one embodiment, for at least one identified current financial transaction data segment represented by current financial transaction data segment data, current financial transaction data segment score data is generated representing the determined current financial transaction data segment score associated with the current financial transaction data segment data.

In accordance with one embodiment, for at least one identified current financial transaction data segment represented by current financial transaction data segment data, the determined current financial transaction data segment score data associated with the current financial transaction data segment data and the threshold financial transaction data segment score data representing the defined threshold financial transaction data segment score are analyzed and compared.

In accordance with one embodiment, if the determined current financial transaction data segment score associated with the current financial transaction data segment data as represented by the current financial transaction data segment score data is greater than the defined threshold financial transaction data segment score represented by the threshold financial transaction data segment score data, financial transaction categorization data representing a financial transaction category assigned to the current financial transaction data is transformed into financial transaction categorization data identifying the current financial transaction data as potential first financial transaction category financial transaction data.

The embodiments disclosed herein provide a method and system for providing an efficient, effective, and dynamically adaptable technical solution to the long standing technical problem in the financial transaction data management, data processing, and user experience arts of providing accurate categorization of financial transaction data that is relatively simple, leverages financial transaction categorization data from other parties, is largely automatic, and is accurate without being overly burdensome on the user, the financial management system, and/or data processing systems.

As a specific illustrative example, when the embodiments disclosed herein are used with a financial management system designed to help a self-employed user track their expenses, prepare their taxes, and/or manage their income needs, the defined first and second financial transaction categories can be business expenses and personal expenses. Consequently, the embodiments disclosed herein provide the financial management system the ability to categorize financial transaction data representing various financial transactions conducted by, or on behalf of the user, as either business expenses, i.e., those in Form 1040 schedule C categories, or personal expenses in an efficient, automatic, and accurate manner.

As an even more specific illustrative example, when the embodiments disclosed herein are used with a financial management system designed to help a self-employed user track their expenses, prepare their taxes, and/or manage their income needs, the defined first and second financial transaction categories can simply be defined as business expenses and all other expenses. Therefore, more potential business transactions can be identified automatically. This is significant since, as noted above, the more automated the categorization process and the more financial transactions tentatively categorized, reasonably, as business expense transactions, the more the user will value the financial management system and continue to use the financial management system to obtain the most benefit from the financial management system.

However, the disclosed method and system for automatically categorizing financial transaction data does not encompass, embody, or preclude other forms of innovation in the area of financial transaction data processing and financial transaction data categorization. In addition, the disclosed method and system for automatically categorizing financial transaction data is not related to any fundamental economic practice, fundamental data processing practice, mental steps, or pen and paper based solution. In fact, the disclosed embodiments are directed to providing solutions to the relatively new problems associated with the automatic processing, categorization, and display of electronic financial transaction data obtained from multiple sources and the leveraging, management, and processing of large amounts of data, i.e., “big data.” Consequently, the disclosed method and system for automatically categorizing financial transaction data is not directed to, does not encompass, and is not merely, an abstract idea or concept.

In addition, the disclosed method and system for automatically categorizing financial transaction data provides for significant improvements to the technical fields of electronic transaction data processing, information dissemination, data processing, data management, data filtering and mining, automatic categorization of data, and user experience.

In addition, implementation of the disclosed method and system for automatically categorizing financial transaction data results in more efficient use of human and non-human resources, fewer processor cycles being utilized, reduced memory utilization, and less communications bandwidth being utilized to relay data to, and from, backend systems and client systems.

As a result, computing systems are transformed into faster, more efficient, and more effective computing systems by implementing the method and system for automatically categorizing financial transaction data.

### BRIEF DESCRIPTION OF THE DRAWINGS

FIG. 1 is a block diagram of an architecture for providing a method and system for providing an intuitive and interactive categorization display in accordance with one embodiment;

FIG. 2 is a flow chart representing one example of a process for automatically categorizing financial transaction data in accordance with one embodiment;

FIG. 3 is a table showing empirical results obtained using different defined threshold financial transaction data segment scores within one embodiment of a process for automatically categorizing financial transaction data;

FIG. 4 is a high level flow diagram showing examples of the normalization and segmentation of financial transaction data in accordance with one embodiment;

FIG. 5 is a high level diagram of an illustrative example of one embodiment of an average score based determination of a current financial transaction data segment score in accordance with one embodiment;

FIG. 6 is a high level diagram of an illustrative example of one embodiment of a lower bound binomial confidence score based determination of a current financial transaction data segment score in accordance with one embodiment; and

FIG. 7 shows one illustrative example of a user interface display informing the user of a financial transaction data categorization transformation and requesting user confirmation and/or approval of the transformation.

Common reference numerals are used throughout the FIG.s and the detailed description to indicate like elements. One skilled in the art will readily recognize that the above FIG.s are examples and that other architectures, modes of operation, orders of operation, and elements/functions can be provided and implemented without departing from the characteristics and features of the invention, as set forth in the claims.

### TERM DEFINITIONS

Embodiments will now be discussed with reference to the accompanying FIG.s, which depict one or more exemplary embodiments. Embodiments may be implemented in many different forms and should not be construed as limited to the embodiments set forth herein, shown in the FIG.s, and/or described below. Rather, these exemplary embodiments are provided to allow a complete disclosure that conveys the principles of the invention, as set forth in the claims, to those of skill in the art.

Herein, a financial management system can be, but is not limited to, any data management system implemented on a computing system, accessed through one or more servers, accessed through a network, accessed through a cloud, and/or provided through any system or by any means, as discussed herein, and/or as known in the art at the time of filing, and/or as developed after the time of filing, that gathers financial data, including financial transactional data, from one or more sources and/or has the capability to analyze and categorize at least part of the financial data.

As used herein, the term financial management system includes, but is not limited to the following: computing system implemented, and/or online, and/or web-based, personal and/or business financial management systems, services, packages, programs, modules, or applications; computing system implemented, and/or online, and/or web-based, personal and/or business tax preparation systems, services, packages, programs, modules, or applications; computing system implemented, and/or online, and/or web-based, personal and/or business accounting and/or invoicing systems, services, packages, programs, modules, or applications; and various other personal and/or business electronic data management systems, services, packages, programs, modules, or applications, whether known at the time of filling or as developed later.

Specific examples of financial management systems include, but are not limited to the following: QuickBooks™, available from Intuit, Inc. of Mountain View, Calif.; QuickBooks On-Line™, available from Intuit, Inc. of Mountain View, Calif.; QuickBooks Self-Employed available from Intuit, Inc. of Mountain View, Calif.; Mint™, available from Intuit, Inc. of Mountain View, Calif.; Mint On-Line™, available from Intuit, Inc. of Mountain View, Calif.; TurboTax™, available from Intuit, Inc. of Mountain View, Calif., and/or various other financial management systems discussed herein, and/or known to those of skill in the art at the time of filing, and/or as developed after the time of filing.

As used herein, the terms “computing system,” “computing device,” and “computing entity,” include, but are not limited to, the following: a server computing system; a workstation; a desktop computing system; a mobile computing system, including, but not limited to, smart phones, portable devices, and/or devices worn or carried by a user; a database system or storage cluster; a virtual asset; a switching system; a router; any hardware system; any communications system; any form of proxy system; a gateway system; a firewall system; a load balancing system; or any device, subsystem, or mechanism that includes components that can execute all, or part, of any one of the processes and/or operations as described herein.

In addition, as used herein, the terms “computing system” and “computing entity,” can denote, but are not limited to, the following: systems made up of multiple virtual assets, server computing systems, workstations, desktop computing systems, mobile computing systems, database systems or storage clusters, switching systems, routers, hardware systems, communications systems, proxy systems, gateway systems, firewall systems, load balancing systems, or any devices that can be used to perform the processes and/or operations as described herein.

Herein, the terms “mobile computing system” and “mobile device” are used interchangeably and include, but are not limited to the following: a smart phone; a cellular phone; a digital wireless telephone; a tablet computing system; a notebook computing system; any portable computing system; a two-way pager; a Personal Digital Assistant (PDA); a media player; an Internet appliance; devices worn or carried by a user; or any other movable/mobile device and/or computing system that includes components that can execute all, or part, of any one of the processes and/or operations as described herein.

Herein, the term “production environment” includes the various components, or assets, used to deploy, implement, access, and use, a given application as that application is intended to be used. In various embodiments, production environments include multiple computing systems and/or assets that are combined, communicatively coupled, virtually and/or physically connected, and/or associated with one another, to provide the production environment implementing the application.

As specific illustrative examples, the assets making up a given production environment can include, but are not limited to, the following: one or more computing environments used to implement the application in the production environment such as a data center, a cloud computing environment, a dedicated hosting environment, and/or one or more other computing environments in which one or more assets used by the application in the production environment are implemented; one or more computing systems or computing entities used to implement the application in the production environment; one or more virtual assets used to implement the application in the production environment; one or more supervisory or control systems, such as hypervisors, or other monitoring and management systems used to monitor and control assets and/or components of the production environment; one or more communications channels for sending and receiving data used to implement the application in the production environment; one or more access control systems for limiting access to various components of the production environment, such as firewalls and gateways; one or more traffic and/or routing systems used to direct, control, and/or buffer data traffic to components of the production environment, such as routers and switches; one or more communications endpoint proxy systems used to buffer, process, and/or direct data traffic, such as load balancers or buffers; one or more secure communication protocols and/or endpoints used to encrypt/decrypt data, such as Secure Sockets Layer (SSL) protocols, used to implement the application in the production environment; one or more databases used to store data in the production environment; one or more internal or external services used to implement the application in the production environment; one or more backend systems, such as backend servers or other hardware used to process data and implement the application in the production environment; one or more software systems used to implement the application in the production environment; and/or any other assets/components making up an actual production environment in which an application is deployed, implemented, accessed, and run, e.g., operated, as discussed herein, and/or as known in the art at the time of filing, and/or as developed after the time of filing.

As used herein, the term “computing environment” includes, but is not limited to, a logical or physical grouping of connected or networked computing systems and/or virtual assets using the same infrastructure and systems such as, but not limited to, hardware systems, software systems, and networking/communications systems. Typically, computing environments are either known, “trusted” environments or unknown, “untrusted” environments. Typically, trusted computing environments are those where the assets, infrastructure, communication and networking systems, and security systems associated with the computing systems and/or virtual assets making up the trusted computing environment, are either under the control of, or known to, a party.

In various embodiments, each computing environment includes allocated assets and virtual assets associated with, and controlled or used to create, and/or deploy, and/or operate an application.

In various embodiments, one or more cloud computing environments are used to create, and/or deploy, and/or operate an application that can be any form of cloud computing environment, such as, but not limited to, a public cloud; a private cloud; a virtual private network (VPN); a subnet; a Virtual Private Cloud (VPC); a sub-net or any security/communications grouping; or any other cloud-based infrastructure, sub-structure, or architecture, as discussed herein, and/or as known in the art at the time of filing, and/or as developed after the time of filing.

In many cases, a given application or service may utilize, and interface with, multiple cloud computing environments, such as multiple VPCs, in the course of being created, and/or deployed, and/or operated.

As used herein, the term “virtual asset” includes any virtualized entity or resource, and/or virtualized part of an actual, or “bare metal” entity. In various embodiments, the virtual assets can be, but are not limited to, the following: virtual machines, virtual servers, and instances implemented in a cloud computing environment; databases associated with a cloud computing environment, and/or implemented in a cloud computing environment; services associated with, and/or delivered through, a cloud computing environment; communications systems used with, part of, or provided through a cloud computing environment; and/or any other virtualized assets and/or sub-systems of “bare metal” physical devices such as mobile devices, remote sensors, laptops, desktops, point-of-sale devices, etc., located within a data center, within a cloud computing environment, and/or any other physical or logical location, as discussed herein, and/or as known/available in the art at the time of filing, and/or as developed/made available after the time of filing.

In various embodiments, any, or all, of the assets making up a given production environment discussed herein, and/or as known in the art at the time of filing, and/or as developed after the time of filing can be implemented as one or more virtual assets.

In one embodiment, two or more assets, such as computing systems and/or virtual assets, and/or two or more computing environments are connected by one or more communications channels including but not limited to, Secure Sockets Layer (SSL) communications channels and various other secure communications channels, and/or distributed computing system networks, such as, but not limited to the following: a public cloud; a private cloud; a virtual private network (VPN); a subnet; any general network, communications network, or general network/communications network system; a combination of different network types; a public network; a private network; a satellite network; a cable network; or any other network capable of allowing communication between two or more assets, computing systems, and/or virtual assets, as discussed herein, and/or available or known at the time of filing, and/or as developed after the time of filing.

As used herein, the term “network” includes, but is not limited to, any network or network system such as, but not limited to, the following: a peer-to-peer network; a hybrid peer-to-peer network; a Local Area Network (LAN); a Wide Area Network (WAN); a public network, such as the Internet; a private network; a cellular network; any general network, communications network, or general network/communications network system; a wireless network; a wired network; a wireless and wired combination network; a satellite network; a cable network; any combination of different network types; or any other system capable of allowing communication between two or more assets, virtual assets, and/or computing systems, whether available or known at the time of filing or as later developed.

As used herein, the term “user experience” includes not only the data entry process, but also other user experience features provided or displayed to the user such as, but not limited to the following: interfaces; images; backgrounds; avatars; highlighting mechanisms; icons; and any other features that individually, or in combination, create a user experience, as discussed herein, and/or as known in the art at the time of filing, and/or as developed after the time of filing.

Herein, the term “party,” “user,” “user consumer,” and “customer” are used interchangeably to denote any party and/or entity that interfaces with, and/or to whom information is provided by, the method and system for automatically categorizing financial transaction data described herein, and/or a person and/or entity that interfaces with, and/or to whom information is provided by, the method and system for automatically categorizing financial transaction data described herein, and/or a legal guardian of person and/or entity that interfaces with, and/or to whom information is provided by, the method and system for automatically categorizing financial transaction data described herein, and/or an authorized agent of any party and/or person and/or entity that interfaces with, and/or to whom information is provided by, the method and system for automatically categorizing financial transaction data described herein. For instance, in various embodiments, a user can be, but is not limited to, a person, a commercial entity, an application, a service, and/or a computing system.

### DETAILED DESCRIPTION

In accordance with one embodiment, a first financial transaction category is defined, such as, but not limited to, a business expense financial transaction category.

In one embodiment, financial transaction data representing a current financial transaction is processed and divided into financial transaction data segments of one of more words or symbols.

In one embodiment, a financial transaction data segment in the current financial transaction is assigned a financial transaction data segment score based on an analysis of historical financial transaction categorizations of historical financial transactions containing the same financial transaction data segment.

In one embodiment, the calculated financial transaction data segment score is compared with a defined threshold financial transaction data segment score and if the calculated financial transaction data segment score is greater than the threshold financial transaction data segment score, the financial transaction containing the financial transaction data segment is categorized, at least temporarily, as being a first financial transaction category financial transaction.

Consequently, in one embodiment, the calculated financial transaction data segment score is used to determine the likelihood of the current financial transaction being assigned a first financial transaction category, such as a business and/or tax related financial transaction category, based on an analysis of historical financial transaction categorizations of historical financial transactions containing the same financial transaction data segment and a defined threshold financial transaction data segment score.

Therefore, the embodiments discussed herein represent an efficient, effective, and dynamically adaptable technical solution to the long standing technical problem in the financial transaction data management, data processing, and user experience arts of providing accurate categorization of financial transaction data that is relatively simple, leverages financial transaction categorization data from other parties, is largely automatic, and is accurate without being overly burdensome on the user, the financial management system, and/or data processing systems.

In one embodiment, a method and system for automatically categorizing financial transaction data includes defining two or more financial transaction categories to be applied to, or otherwise associated with, one or more financial transactions represented in financial transaction data.

In various embodiments, the financial transaction categories represent financial transaction categories used to categorize and process various financial transactions associated with the user. In various embodiments, the financial transaction categories are defined by the provider of the method and system for automatically categorizing financial transaction data. In other embodiments, the financial transaction categories are defined by one or more financial management systems such as, but not limited to, any of the financial management systems as discussed herein, and/or as known in the art at the time of filing, and/or as developed after the time of filing.

Herein, a financial management system can be, but is not limited to, any data management system that gathers financial data, including financial transactional data, from one or more sources, such as financial accounts and financial institutions, and/or has the capability to analyze and categorize at least part of the financial data.

Current financial management systems are typically software applications and/or web-based services, which, along with a parent computing system, server system, or device, help individuals/users manage their finances by providing a centralized interface with banks, credit card companies, and various other financial and asset management institutions and/or accounts, for identifying, processing, storing, and categorizing user financial transactions. Currently, financial management systems typically obtain financial transaction data, such as payee identification, payment amount, date of the transaction, time of transaction, etc., via communication with banks, credit card providers, or other financial institutions, using data entry, and/or links to databases, and/or screen scraping technology, and/or electronic data transfer systems, such as the Open Financial Exchange (OFX) specification, and/or various other systems for obtaining and transferring financial transaction data.

Using some financial management systems, the financial transaction data, payee identification, payment amount, date of the transaction, various descriptions, tags and/or labels, and/or other identifying data is used by the financial management system to identify, categorize, and/or tag individual financial transactions as a particular type of income or expense, to generate various financial reports, to determine a user's tax liability, and to create an overview of the user's financial situation based on input from multiple, and preferably all, available sources of financial information/data regarding a user.

In some embodiments, the financial transaction categories are defined by outside agencies such as, but not limited to, the Internal Revenue Service (IRS) or other state and local tax agencies.

In one embodiment, the financial transaction categories are broad financial transaction categories that include, or encompass, one or more of financial transaction sub-categories as discussed below. In one embodiment, the financial transaction categories are defined in pairs of financial transaction categories that are representative of a broad categorization of various subsets of financial transaction categories.

One long standing problem associated with traditional financial management system displays is the inability to present users their financial information in an efficient, relevant, intuitive, interactive, and dynamic way that is of practical use. However, in some of the disclosed embodiments, by dividing the user's spending transactions between relatively few, in one embodiment only one or two, financial transaction categories, the user is provided a straightforward display including, in one specific illustrative example, only personal and business financial transaction categories.

For instance, in one embodiment, the two or more financial transaction categories include, but are not limited to, a personal and business expense financial transaction category pair. In one embodiment, the business expense financial transaction category includes, but is not limited to, business expenses that are associated with IRS Form 1040 schedule C categories.

In one specific example, the pair of financial transaction categories include “personal” and “business” financial transaction categories where the “personal” financial transaction category is applied to personal related expenses as opposed to “business” related expenses that have tax ramifications. Consequently, in one embodiment, the two or more financial transaction categories include, but are not limited to, a business expense financial transaction category and an “all other” financial transaction category. In one embodiment, the business expense financial transaction category includes, but is not limited to, business expenses that are associated with IRS Form 1040 schedule C categories.

In one embodiment, the two or more financial transaction categories include, but are not limited to, a personal and business travel financial transaction category pair.

In another specific example, two or more financial transaction categories include, but are not limited to, a “wants” financial transaction category representing discretionary spending financial transactions and a “needs” financial transaction category representing non-discretionary financial transactions. In this specific illustrative example, the financial transaction categories are used to distinguish between financial transactions, and associated financial transaction categories, over which the user has control, i.e., that are associated with spending that is not required, but rather represents desired spending on a “wanted” item or service, as opposed to financial transactions, and associated financial transaction categories, over which the user has no control, i.e., that are associated with spending that is required and is not optional, such as utilities, rent, mortgage, etc.

In another specific example, two or more financial transaction categories include, but are not limited to, a “discretionary” and “non-discretionary” financial transaction category pair.

Other examples of financial transaction categories include any financial transaction categories as discussed herein, and/or as known in the art at the time of filing, and/or as developed after the time of filing.

In one embodiment, once at least two financial transaction categories are defined, financial transaction category data representing the defined financial transaction categories is generated.

In one embodiment, once the financial transaction categories are defined and financial transaction category data is generated, a threshold financial transaction data segment score is defined such that financial transaction data including a financial transaction data segment having a financial transaction data segment score greater than the defined threshold financial transaction data segment score is identified as potential first financial transaction category financial transaction data and financial transaction data including a financial transaction data segment having a financial transaction data segment score not greater than the defined threshold financial transaction data segment score is identified as potential second financial transaction category financial transaction data.

In various embodiments, the threshold financial transaction data segment score is defined based on a balance between several factors including. These factors can include, but are not limited to: accuracy, e.g., the model and the truth match up of the eventual financial transaction data categorization desired; prevalence, e.g., the proportion of financial transactions marked as business category financial transactions by the model, associated with the defined threshold financial transaction data segment score; precision, e.g., the proportion of business financial transactions marked by model that are actually business financial transactions of the eventual financial transaction data categorization desired; and the recall, e.g., the proportion of actual business financial transactions that are correctly identified by the model, using the defined threshold financial transaction data segment score.

In accordance with one embodiment, historical financial transaction data is obtained. In one embodiment, the historical financial transaction data represents historical financial transactions conducted by one or more parties. In one embodiment, the historical financial transaction data includes historical financial transaction categorization data indicating a financial transaction category assigned to the historical financial transactions represented in the historical financial transaction data.

In accordance with one embodiment, historical financial transaction data is obtained from one or more financial management systems and/or other financial transaction data sources, such as any of the financial management systems and/or other financial transaction data sources discussed herein, and/or as known in the art at the time of filing, and/or as developed after the time of filing, and/or by any means as discussed herein, and/or as known in the art at the time of filing, and/or as becomes known after the time of filing.

In one embodiment, the historical financial transaction data is financial transaction data from a defined relevant period of time such as, a day, a week, a month, quarter, a year, etc. In various embodiments the relevant period of time is defined by the user, and/or provider, of the method and system for automatically categorizing financial transaction data.

In one embodiment, once the historical financial transaction data is obtained, the historical financial transaction data is subjected to an initial processing whereby the historical financial transaction data is analyzed with financial transaction data segmentation rules data to identify historical financial transaction data segments represented by historical financial transaction data segment data.

In one embodiment, the financial transaction data segmentation rules data dictates that the identified historical financial transaction data segments represented by the historical financial transaction data segment data include a word or symbol in the historical financial transaction data segment.

In one embodiment, the financial transaction data segmentation rules data dictates that the identified historical financial transaction data segments represented by the historical financial transaction data segment data include two or more words or symbols. In one embodiment, the financial transaction data segmentation rules data dictates that the two or more words or symbols are adjacent to one another within the historical financial transaction data. In one embodiment, the financial transaction data segmentation rules data dictates that the two or more words or symbols are within a defined number of words or symbols with respect to each other within the historical financial transaction data.

In various embodiments, the financial transaction data segmentation rules data dictates any segmentation and/or processing rules discussed herein, and/or as known in the art at the time of filing, and/or as developed after the time of filing.

In accordance with one embodiment, for at least one identified historical financial transaction data segment represented by historical financial transaction data segment data, historical financial transaction category data representing the historical financial transaction category assigned to the historical financial transaction represented in the historical financial transaction data including the historical financial transaction data segment is obtained.

In one embodiment, the historical financial transaction category data for at least one identified historical financial transaction data segment includes data indicating historical financial transaction categories applied to the financial transaction data including the historical financial transaction data segment by one or more parties and/or the current user of the financial management system.

In one embodiment, the historical financial transaction category data for at least one identified historical financial transaction data segment includes categorization data manually entered by the one or more parties and/or the current user of the financial management system.

In one embodiment, the historical financial transaction category data for at least one identified historical financial transaction data segment includes categorization data in the form of approval data associated with automatic categorizations entered by the one or more parties and/or the current user of the financial management system.

In one embodiment, the historical financial transaction category data for at least one identified historical financial transaction data segment includes data indicating a number of historical financial transactions that include the current financial transaction data segment.

In one embodiment, the historical financial transaction category data for at least one identified historical financial transaction data segment includes data indicating the number of unique, i.e., different, parties associated with the determined number of historical financial transactions that include the current financial transaction data segment.

In one embodiment, the historical financial transaction category data for at least one identified historical financial transaction data segment includes data indicating the number of the historical financial transactions that include the current financial transaction data segment that were categorized as being of the first financial transaction category, or any other financial transaction category of interest.

In one embodiment, the historical financial transaction category data for at least one identified historical financial transaction data segment includes any data desired and/or as discussed herein, and/or as known in the art at the time of filing, and/or as developed after the time of filing.

In accordance with one embodiment, for at least one identified historical financial transaction data segment represented by historical financial transaction data segment data, the historical financial transaction data segment data representing that historical financial transaction data segment is correlated to historical financial transaction category data representing the historical financial transaction category assigned to the historical financial transaction represented in the historical financial transaction data including the historical financial transaction data segment. In this way, correlated historical financial transaction data segment data and historical financial transaction category data is generated.

In accordance with one embodiment, current financial transaction data representing a financial transaction associated with a user is obtained. In one embodiment, the current financial transaction data is obtained from one or more financial management systems and/or other financial transaction data sources, such as any of the financial management systems and/or other financial transaction data sources discussed herein, and/or as known in the art at the time of filing, and/or as developed after the time of filing, and/or by any means as discussed herein, and/or as known in the art at the time of filing, and/or as becomes known after the time of filing.

In accordance with one embodiment, the obtained current financial transaction data is normalized to generate normalized current financial transaction data. In various embodiments, the obtained current financial transaction data is normalized to remove irrelevant text and symbols from the current financial transaction data in accordance with one or more normalization rules represented by normalization rules data.

In one embodiment, once the normalized current financial transaction data is generated, the normalized current financial transaction data is subjected to an initial processing whereby the normalized current financial transaction data is analyzed with the same, or similar, financial transaction data segmentation rules data applied to the historical financial transaction data discussed above. In one embodiment, one or more current financial transaction data segments are thereby identified and represented by current financial transaction data segment data.

In one embodiment, the financial transaction data segmentation rules data dictates that the identified current financial transaction data segments represented by the current financial transaction data segment data include a word or symbol in the current financial transaction data segment.

In one embodiment, the financial transaction data segmentation rules data dictates that the identified current financial transaction data segments represented by the current financial transaction data segment data include two or more words or symbols. In one embodiment, the financial transaction data segmentation rules data dictates that the two or more words or symbols are adjacent to one another within the current financial transaction data. In one embodiment, the financial transaction data segmentation rules data dictates that the two or more words or symbols are within a defined number of words or symbols with respect to each other within the current financial transaction data.

In various embodiments, the financial transaction data segmentation rules data dictates any segmentation and/or processing rules discussed herein, and/or as known in the art at the time of filing, and/or as developed after the time of filing.

In accordance with one embodiment, for at least one identified current financial transaction data segment represented by current financial transaction data segment data, the correlated historical financial transaction data segment data and historical financial transaction category data for that current financial transaction data segment is obtained and analyzed to determine a current financial transaction data segment score.

In one embodiment, for at least one identified current financial transaction data segment represented by current financial transaction data segment data, current financial transaction data segment score data is generated representing the determined current financial transaction data segment score associated with the current financial transaction data segment data.

In one embodiment, a current financial transaction data segment score to be associated with at least one identified current financial transaction data segment is determined by using the correlated historical financial transaction data segment data and historical financial transaction category data for that current financial transaction data segment to:
a. Determine a number of historical financial transactions that include the current financial transaction data segment;
b. Determine the number of unique, i.e., different, parties associated with the determined number of historical financial transactions that include the current financial transaction data segment;
c. Determine the number of the historical financial transactions that include the current financial transaction data segment that were categorized as being of the first financial transaction category;
d. Determine the number of unique parties that categorized the historical financial transactions that include the current financial transaction data segment as being of the first financial transaction category;
e. Divide the number of the historical financial transactions that include the current financial transaction data segment that were categorized as being of the first financial transaction category by the number of historical financial transactions that include the current financial transaction data segment;
f. Divide the number of unique parties that categorized the historical financial transactions that include the current financial transaction data segment as being of the first financial transaction category by the number of unique parties associated with the determined number of historical financial transactions that include the current financial transaction data segment; and
g. Assign a current financial transaction data segment score to the current financial transaction data segment data that is equal to the value of the number of the historical financial transactions that include the current financial transaction data segment that were categorized as being of the first financial transaction category divided by the number of historical financial transactions that include the current financial transaction data segment, or the number of unique parties that categorized the historical financial transactions that include the current financial transaction data segment as being of the first financial transaction category divided by the number of unique parties associated with the determined number of historical financial transactions that include the current financial transaction data segment.

In accordance with one embodiment, the current financial transaction data segment score assigned to current financial transaction data segment data is equal to the lower of the value of:
a. The number of the historical financial transactions that include the current financial transaction data segment that were categorized as being of the first financial transaction category divided by the number of historical financial transactions that include the current financial transaction data segment; or
b. The number of unique parties that categorized the historical financial transactions that include the current financial transaction data segment as being of the first financial transaction category divided by the number of unique parties associated with the determined number of historical financial transactions that include the current financial transaction data segment.

In one embodiment, a current financial transaction data segment score to be associated with at least one identified current financial transaction data segment is determined by using the correlated historical financial transaction data segment data and historical financial transaction category data for that current financial transaction data segment to determine a binomial confidence interval for the current financial transaction data segment and then using the lower bound of the binomial confidence interval for the current financial transaction data segment as the current financial transaction data segment score.

In one embodiment, a current financial transaction data segment score to be associated with at least one identified current financial transaction data segment is determined by using any method, process, system, and/or procedure for determining a current financial transaction data segment score desired, and/or as discussed herein, and/or as known in the art at the time of filing, and/or as developed after the time of filing.

In accordance with one embodiment, for at least one identified current financial transaction data segment represented by current financial transaction data segment data, the determined current financial transaction data segment score data associated with the current financial transaction data segment data and the threshold financial transaction data segment score data representing the defined threshold financial transaction data segment score are analyzed and compared.

In accordance with one embodiment, if the determined current financial transaction data segment score associated with the current financial transaction data segment data as represented by the current financial transaction data segment score data is greater than the defined threshold financial transaction data segment score represented by the threshold financial transaction data segment score data, financial transaction categorization data representing a financial transaction category assigned to the current financial transaction data is transformed into financial transaction categorization data identifying the current financial transaction data as potential first financial transaction category financial transaction data.

In one embodiment, once the financial transaction categorization data representing a financial transaction category assigned to the current financial transaction data is transformed to financial transaction categorization data identifying the current financial transaction data as potential first financial transaction category financial transaction data or potential second financial transaction category financial transaction data, the user is informed of the transformation.

In one embodiment, once the financial transaction categorization data representing a financial transaction category assigned to the current financial transaction data is transformed to financial transaction categorization data identifying the current financial transaction data as potential first financial transaction category financial transaction data or potential second financial transaction category financial transaction data, the user is informed of the transformation and user confirmation and/or approval of the transformation is requested/required.

The embodiments disclosed herein provide a method and system for providing an efficient, effective, and dynamically adaptable technical solution to the long standing technical problem in the financial transaction data management, data processing, and user experience arts of providing accurate categorization of financial transaction data that is relatively simple, leverages financial transaction categorization data from other parties, is largely automatic, and is accurate without being overly burdensome on the user, the financial management system, and/or data processing systems.

As a specific illustrative example, when the embodiments disclosed herein are used with a financial management system designed to help a self-employed user track their expenses, prepare their taxes, and/or manage their income needs, the defined first and second financial transaction categories can be business expenses and personal expenses. Consequently, the embodiments disclosed herein provide the financial management system the ability to categorize financial transaction data representing various financial transactions conducted by, or on behalf of the user, as either business expenses, i.e., those in Form 1040 schedule C categories, or personal expenses in an efficient, automatic, and accurate manner.

As an even more specific illustrative example, when the embodiments disclosed herein are used with a financial management system designed to help a self-employed user track their expenses, prepare their taxes, and/or manage their income needs, the defined first and second financial transaction categories can simply be defined as business expenses and all other expenses. Therefore, more potential business transactions can be identified automatically. This is significant since, as noted above, the more automated the categorization process and the more financial transactions tentatively categorized, reasonably, as business expense transactions, the more the user will value the financial management system and continue to use the financial management system to obtain the most benefit from the financial management system.

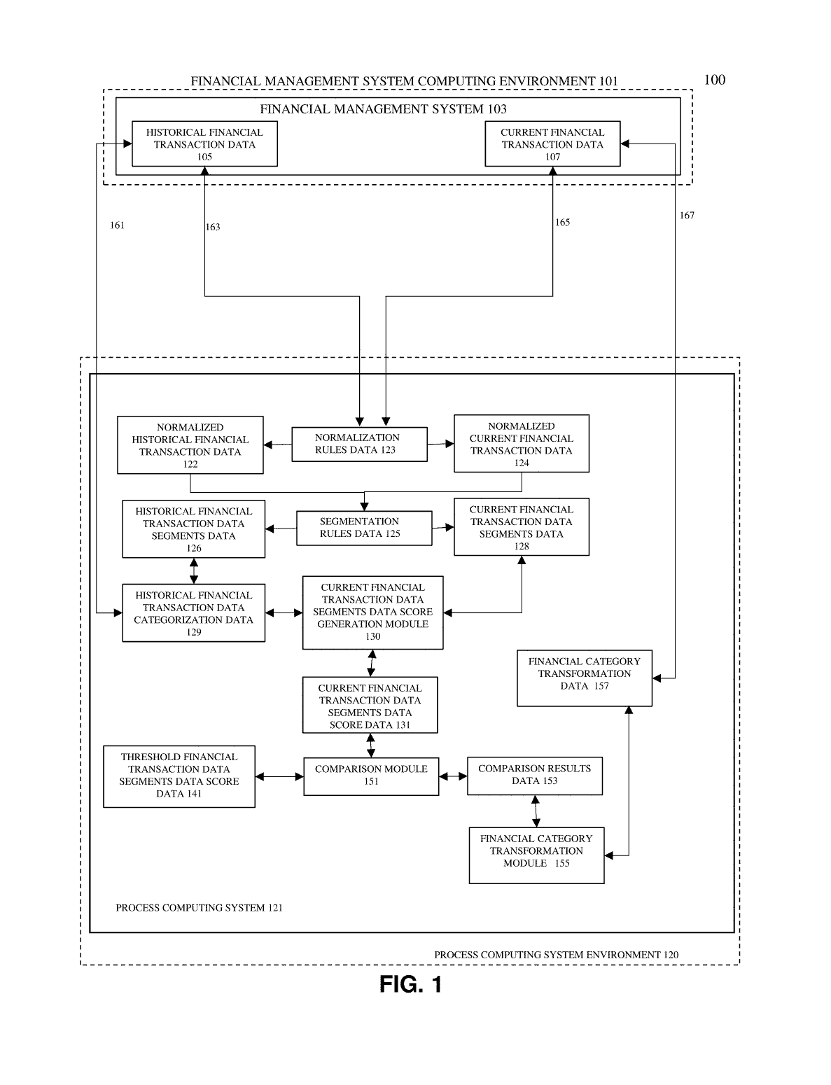

FIG. 1 is a block diagram of a hardware and production environment 100 for implementing a method and system for automatically categorizing financial transaction data. As seen in FIG. 1, financial management system 103 is shown implemented in financial management system computing environment 101 and process computing system 121 is shown implemented in process computing system environment 120.

As seen in FIG. 1, financial management system computing environment 101 and financial management system 103 are communicatively coupled to process computing system environment 120 and process computing system 121 via communications channels 161, 163, 165, and 167.

As seen in FIG. 1, in one embodiment, financial management system 103 includes historical financial transaction data 105 and current financial transaction data 107.

As seen in FIG. 1, process computing system environment 120 includes: normalized historical financial transaction data 122 and normalized current financial transaction data 124 generated by applying normalization rules data 123 to historical financial transaction data 105 and current financial transaction data 107, respectively; historical financial transaction data segments data 126 and current financial transaction data segments data 128 generated by applying segmentation rules data 125 to normalized historical financial transaction data 122 and normalized current financial transaction data 124, respectively; current financial transaction data segments data score generation module 130 generating current financial transaction data segments data score data 131 by analyzing historical financial transaction data categorization data 129 and current financial transaction data segments data 128; comparison module 151 for comparing current financial transaction data segments data score data 131 and threshold financial transaction data segments data score data 141 to generate comparison results data 153; and financial category transformation module 155 for generating financial category transformation data 157.

In one embodiment, threshold financial transaction data segments data score data 141 is generated representing a defined threshold financial transaction data segment score such that financial transaction data including a financial transaction data segment having a financial transaction data segment score greater than the defined threshold financial transaction data segment score is identified as potential first financial transaction category financial transaction data.

In one embodiment, historical financial transaction data 105 representing historical financial transactions is obtained from financial management system 103. In one embodiment historical financial transaction data 105 includes historical financial transaction categorization data 129 indicating a financial transaction category assigned to the historical financial transactions represented in historical financial transaction data 105.

In one embodiment, historical financial transaction data 105 is normalized by applying normalization rules data 123 to historical financial transaction data 105 to generate normalized historical financial transaction data 122.

In one embodiment, normalized historical financial transaction data 122 is processed by applying segmentation rules data 125 to normalized historical financial transaction data 122 to generate historical financial transaction data segments data 126 including historical financial transaction data segments of one of more words or symbols.

In one embodiment, for at least one identified historical financial transaction data segment represented by historical financial transaction data segments data 126, historical financial transaction data segments data 126 representing that historical financial transaction data segment is correlated to at least a portion of historical financial transaction categorization data 129 indicating a financial transaction category assigned to the historical financial transaction represented in historical financial transaction data 105.

In one embodiment, current financial transaction data 107 representing a current financial transaction is obtained from financial management system 103.

In one embodiment, current financial transaction data 107 is normalized by applying normalization rules data 123 to current financial transaction data 107 to generate normalized current financial transaction data 124.

In one embodiment, normalized current financial transaction data 124 is processed by applying segmentation rules data 125 to normalized current financial transaction data 124 to generate current financial transaction data segments data 128 including current financial transaction data segments of one of more words or symbols.

In one embodiment, for at least one identified current financial transaction data segment represented in current financial transaction data segments data 128 the correlated historical financial transaction data segments data 126 and portion of historical financial transaction categorization data 129 for the current financial transaction data segment is analyzed at current financial transaction data segments data score generation module 130 to determine a current financial transaction data segment score and generate current financial transaction data segments data score data 131.

In one embodiment, at comparison module 151 current financial transaction data segments data score data 131 and threshold financial transaction data segments data score data 141 are analyzed and compared to generate comparison results data 153.

In one embodiment, if comparison results data 153 indicates that current financial transaction data segments data score data 131 is greater than, or equal to, threshold financial transaction data segments data score data 141, financial category transformation module 155 is used to generate financial category transformation data 157 transforming financial transaction categorization data representing a financial transaction category assigned to current financial transaction data 107 to financial transaction categorization data indicating current financial transaction data 107 is potential first financial transaction category financial transaction data.

The embodiments disclosed herein provide a method and system for providing an efficient, effective, and dynamically adaptable technical solution to the long standing technical problem in the financial transaction data management, data processing, and user experience arts of providing accurate categorization of financial transaction data that is relatively simple, leverages financial transaction categorization data from other parties, is largely automatic, and is accurate without being overly burdensome on the user, the financial management system, and/or data processing systems.

However, the disclosed method and system for automatically categorizing financial transaction data does not encompass, embody, or preclude other forms of innovation in the area of financial transaction data processing and financial transaction data categorization. In addition, the disclosed method and system for automatically categorizing financial transaction data is not related to any fundamental economic practice, fundamental data processing practice, mental steps, or pen and paper based solution. In fact, the disclosed embodiments are directed to providing solutions to the relatively new problems associated with the automatic processing, categorization, and display of electronic financial transaction data obtained from multiple sources and the leveraging, management, and processing of large amounts of data, i.e., “big data.” Consequently, the disclosed method and system for automatically categorizing financial transaction data is not directed to, does not encompass, and is not merely, an abstract idea or concept.

In addition, the disclosed method and system for automatically categorizing financial transaction data provides for significant improvements to the technical fields of electronic transaction data processing, information dissemination, data processing, data management, data filtering and mining, automatic categorization of data, and user experience.

In addition, implementation of the disclosed method and system for automatically categorizing financial transaction data results in more efficient use of human and non-human resources, fewer processor cycles being utilized, reduced memory utilization, and less communications bandwidth being utilized to relay data to, and from, backend systems and client systems.

As a result, computing systems are transformed into faster, more efficient, and more effective computing systems by implementing the method and system for automatically categorizing financial transaction data.

### Process

In accordance with one embodiment, a first financial transaction category is defined, such as, but not limited to, a business expense financial transaction category.

In one embodiment, financial transaction data representing a current financial transaction is processed and divided into financial transaction data segments of one of more words or symbols.

In one embodiment, a financial transaction data segment in the current financial transaction is assigned a financial transaction data segment score based on an analysis of historical financial transaction categorizations of historical financial transactions containing the same financial transaction data segment.

In one embodiment, the calculated financial transaction data segment score is compared with a defined threshold financial transaction data segment score and if the calculated financial transaction data segment score is greater than the threshold financial transaction data segment score, the financial transaction containing the financial transaction data segment is categorized, at least temporarily, as being a first financial transaction category financial transaction.

Consequently, in one embodiment, the calculated financial transaction data segment score is used to determine the likelihood of the current financial transaction being assigned a first financial transaction category, such as a business and/or tax related financial transaction category, based on an analysis of historical financial transaction categorizations of historical financial transactions containing the same financial transaction data segment and a defined threshold financial transaction data segment score.

Therefore, the embodiments discussed herein represent an efficient, effective, and dynamically adaptable technical solution to the long standing technical problem in the financial transaction data management, data processing, and user experience arts of providing accurate categorization of financial transaction data that is relatively simple, leverages financial transaction categorization data from other parties, is largely automatic, and is accurate without being overly burdensome on the user, the financial management system, and/or data processing systems.

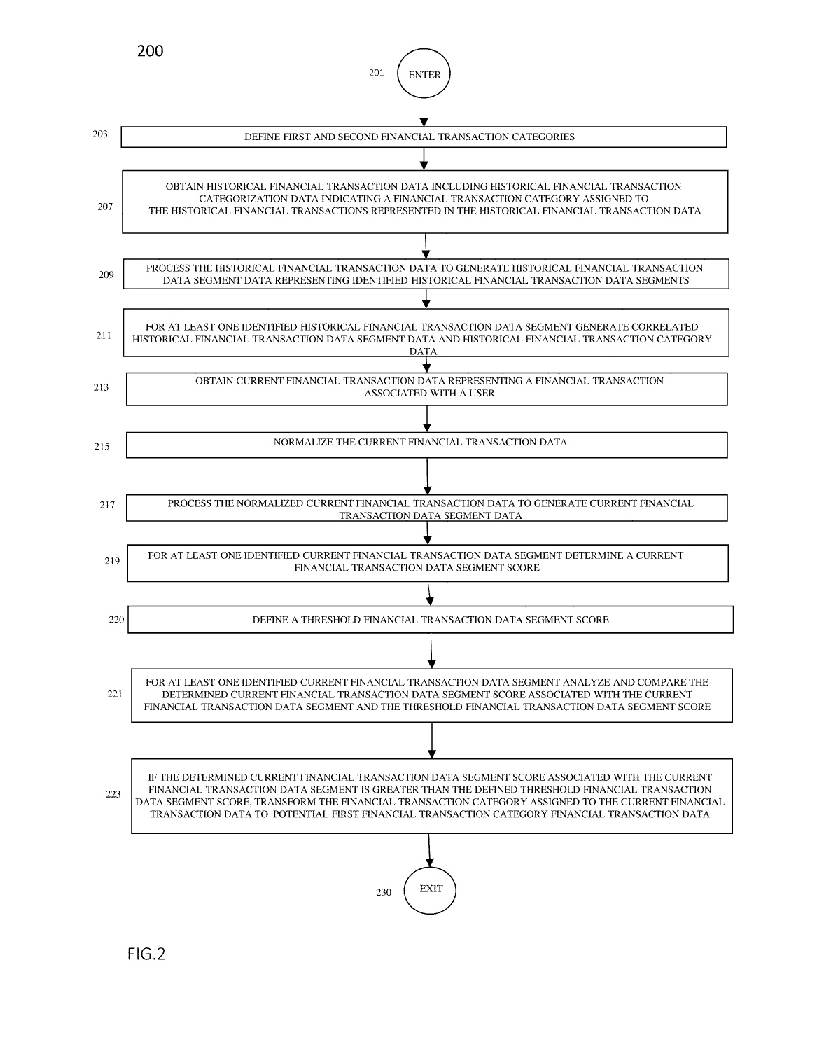

FIG. 2 is a flow chart representing one example of a process 200 for automatically categorizing financial transaction data in accordance with one embodiment.

As seen in FIG. 2, process 200 for automatically categorizing financial transaction data begins at ENTER OPERATION 201 and process flow proceeds to DEFINE FIRST AND SECOND FINANCIAL TRANSACTION CATEGORIES OPERATION 203.

In one embodiment, at DEFINE FIRST AND SECOND FINANCIAL TRANSACTION CATEGORIES OPERATION 203, one or more financial transaction categories to be applied to, or otherwise associated with, one or more financial transactions represented in financial transaction data are defined.

In various embodiments, the financial transaction categories of DEFINE FIRST AND SECOND FINANCIAL TRANSACTION CATEGORIES OPERATION 203 represent financial transaction categories used to categorize and process various financial transactions associated with the user.

In various embodiments, at DEFINE FIRST AND SECOND FINANCIAL TRANSACTION CATEGORIES OPERATION 203 the financial transaction categories are defined by the provider of the process 200 for automatically categorizing financial transaction data. In other embodiments, the financial transaction categories are defined at DEFINE FIRST AND SECOND FINANCIAL TRANSACTION CATEGORIES OPERATION 203 by one or more financial management systems such as, but not limited to, any of the financial management systems as discussed herein, and/or as known in the art at the time of filing, and/or as developed after the time of filing.

In some embodiments, the financial transaction categories of DEFINE FIRST AND SECOND FINANCIAL TRANSACTION CATEGORIES OPERATION 203 are defined by outside agencies such as, but not limited to, the Internal Revenue Service (IRS) or other state and local tax agencies.

In one embodiment, the financial transaction categories of DEFINE FIRST AND SECOND FINANCIAL TRANSACTION CATEGORIES OPERATION 203 are broad financial transaction categories that include, or encompass, one or more of financial transaction sub-categories as discussed below. In one embodiment, the financial transaction categories are defined in pairs of financial transaction categories that are representative of a broad categorization of various subsets of financial transaction categories.

One long standing problem associated with traditional financial management system displays is the inability to present users their financial information in an efficient, relevant, intuitive, interactive, and dynamic way that is of practical use. However, in some of the disclosed embodiments, by dividing the user's spending transactions between relatively few, in one embodiment only one or two, financial transaction categories, at DEFINE FIRST AND SECOND FINANCIAL TRANSACTION CATEGORIES OPERATION 203 the user is provided a straightforward display including, in one specific illustrative example, only personal and business financial transaction categories.

For instance, in one specific example, the pair of financial transaction categories of include “personal” and “business” financial transaction categories where the “personal” financial transaction category is applied to personal related expenses as opposed to “business” related expenses that have tax ramifications.

Consequently, in one embodiment, the two or more financial transaction categories of DEFINE FIRST AND SECOND FINANCIAL TRANSACTION CATEGORIES OPERATION 203 can include, but are not limited to, a business expense financial transaction category and an “all other” financial transaction category. In one embodiment, the business expense financial transaction category includes, but is not limited to, business expenses that are associated with IRS Form 1040 schedule C categories.

In one embodiment, the two or more financial transaction categories of DEFINE FIRST AND SECOND FINANCIAL TRANSACTION CATEGORIES OPERATION 203 include, but are not limited to, a personal and business expense financial transaction category pair. In one embodiment, the business expense financial transaction category includes, but is not limited to, business expenses that are associated with IRS Form 1040 schedule C categories.

In one embodiment, the two or more financial transaction categories of DEFINE FIRST AND SECOND FINANCIAL TRANSACTION CATEGORIES OPERATION 203 include, but are not limited to, a personal and business travel financial transaction category pair.

In another specific example, the two or more financial transaction categories of DEFINE FIRST AND SECOND FINANCIAL TRANSACTION CATEGORIES OPERATION 203 include, but are not limited to, a “wants” financial transaction category representing discretionary spending financial transactions and a “needs” financial transaction category representing non-discretionary financial transactions. In this specific illustrative example, the financial transaction categories are used to distinguish between financial transactions, and associated financial transaction categories, over which the user has control, i.e., that are associated with spending that is not required, but rather represents desired spending on a “wanted” item or service, as opposed to financial transactions, and associated financial transaction categories, over which the user has no control, i.e., that are associated with spending that is required and is not optional, such as utilities, rent, mortgage, etc.

In another specific example, the two or more financial transaction categories of DEFINE FIRST AND SECOND FINANCIAL TRANSACTION CATEGORIES OPERATION 203 include, but are not limited to, a “discretionary” and “non-discretionary” financial transaction category pair.

Other examples of financial transaction categories of DEFINE FIRST AND SECOND FINANCIAL TRANSACTION CATEGORIES OPERATION 203 include any financial transaction categories as discussed herein, and/or as known in the art at the time of filing, and/or as developed after the time of filing.

In one embodiment, once at least two financial transaction categories are defined, financial transaction category data representing the defined financial transaction categories is generated at DEFINE FIRST AND SECOND FINANCIAL TRANSACTION CATEGORIES OPERATION 203.

In one embodiment, once one or more financial transaction categories to be applied to, or otherwise associated with, one or more financial transactions represented in financial transaction data at DEFINE FIRST AND SECOND FINANCIAL TRANSACTION CATEGORIES OPERATION 203, process flow proceeds to OBTAIN HISTORICAL FINANCIAL TRANSACTION DATA INCLUDING HISTORICAL FINANCIAL TRANSACTION CATEGORIZATION DATA INDICATING A FINANCIAL TRANSACTION CATEGORY ASSIGNED TO THE HISTORICAL FINANCIAL TRANSACTIONS REPRESENTED IN THE HISTORICAL FINANCIAL TRANSACTION DATA OPERATION 207.

In one embodiment, at OBTAIN HISTORICAL FINANCIAL TRANSACTION DATA INCLUDING HISTORICAL FINANCIAL TRANSACTION CATEGORIZATION DATA INDICATING A FINANCIAL TRANSACTION CATEGORY ASSIGNED TO THE HISTORICAL FINANCIAL TRANSACTIONS REPRESENTED IN THE HISTORICAL FINANCIAL TRANSACTION DATA OPERATION 207, historical financial transaction data is obtained.

In one embodiment, the historical financial transaction data of OBTAIN HISTORICAL FINANCIAL TRANSACTION DATA INCLUDING HISTORICAL FINANCIAL TRANSACTION CATEGORIZATION DATA INDICATING A FINANCIAL TRANSACTION CATEGORY ASSIGNED TO THE HISTORICAL FINANCIAL TRANSACTIONS REPRESENTED IN THE HISTORICAL FINANCIAL TRANSACTION DATA OPERATION 207 represents historical financial transactions conducted by one or more parties.

In one embodiment, the historical financial transaction data of OBTAIN HISTORICAL FINANCIAL TRANSACTION DATA INCLUDING HISTORICAL FINANCIAL TRANSACTION CATEGORIZATION DATA INDICATING A FINANCIAL TRANSACTION CATEGORY ASSIGNED TO THE HISTORICAL FINANCIAL TRANSACTIONS REPRESENTED IN THE HISTORICAL FINANCIAL TRANSACTION DATA OPERATION 207 includes historical financial transaction categorization data indicating a financial transaction category assigned to the historical financial transactions represented in the historical financial transaction data.

In accordance with one embodiment, historical financial transaction data is obtained at OBTAIN HISTORICAL FINANCIAL TRANSACTION DATA INCLUDING HISTORICAL FINANCIAL TRANSACTION CATEGORIZATION DATA INDICATING A FINANCIAL TRANSACTION CATEGORY ASSIGNED TO THE HISTORICAL FINANCIAL TRANSACTIONS REPRESENTED IN THE HISTORICAL FINANCIAL TRANSACTION DATA OPERATION 207 from one or more financial management systems and/or other financial transaction data sources, such as any of the financial management systems and/or other financial transaction data sources discussed herein, and/or as known in the art at the time of filing, and/or as developed after the time of filing, and/or by any means as discussed herein, and/or as known in the art at the time of filing, and/or as becomes known after the time of filing.

In one embodiment, the historical financial transaction data of OBTAIN HISTORICAL FINANCIAL TRANSACTION DATA INCLUDING HISTORICAL FINANCIAL TRANSACTION CATEGORIZATION DATA INDICATING A FINANCIAL TRANSACTION CATEGORY ASSIGNED TO THE HISTORICAL FINANCIAL TRANSACTIONS REPRESENTED IN THE HISTORICAL FINANCIAL TRANSACTION DATA OPERATION 207 is financial transaction data from a defined relevant period of time such as, a day, a week, a month, quarter, a year, etc. In various embodiments the relevant period of time is defined by the user, and/or provider, of the method and system for automatically categorizing financial transaction data.

In one embodiment, once historical financial transaction data is obtained at OBTAIN HISTORICAL FINANCIAL TRANSACTION DATA INCLUDING HISTORICAL FINANCIAL TRANSACTION CATEGORIZATION DATA INDICATING A FINANCIAL TRANSACTION CATEGORY ASSIGNED TO THE HISTORICAL FINANCIAL TRANSACTIONS REPRESENTED IN THE HISTORICAL FINANCIAL TRANSACTION DATA OPERATION 207, process flow proceeds to PROCESS THE HISTORICAL FINANCIAL TRANSACTION DATA TO GENERATE HISTORICAL FINANCIAL TRANSACTION DATA SEGMENT DATA REPRESENTING IDENTIFIED HISTORICAL FINANCIAL TRANSACTION DATA SEGMENTS OPERATION 209.

In one embodiment, at PROCESS THE HISTORICAL FINANCIAL TRANSACTION DATA TO GENERATE HISTORICAL FINANCIAL TRANSACTION DATA SEGMENT DATA REPRESENTING IDENTIFIED HISTORICAL FINANCIAL TRANSACTION DATA SEGMENTS OPERATION 209, the historical financial transaction data is subjected to an initial processing whereby the historical financial transaction data is analyzed with financial transaction data segmentation rules data to identify historical financial transaction data segments represented by historical financial transaction data segment data.

In one embodiment, at PROCESS THE HISTORICAL FINANCIAL TRANSACTION DATA TO GENERATE HISTORICAL FINANCIAL TRANSACTION DATA SEGMENT DATA REPRESENTING IDENTIFIED HISTORICAL FINANCIAL TRANSACTION DATA SEGMENTS OPERATION 209 the financial transaction data segmentation rules data dictates that the identified historical financial transaction data segments represented by the historical financial transaction data segment data include a word or symbol in the historical financial transaction data segment.

In one embodiment, at PROCESS THE HISTORICAL FINANCIAL TRANSACTION DATA TO GENERATE HISTORICAL FINANCIAL TRANSACTION DATA SEGMENT DATA REPRESENTING IDENTIFIED HISTORICAL FINANCIAL TRANSACTION DATA SEGMENTS OPERATION 209 the financial transaction data segmentation rules data dictates that the identified historical financial transaction data segments represented by the historical financial transaction data segment data include two or more words or symbols.

In one embodiment, at PROCESS THE HISTORICAL FINANCIAL TRANSACTION DATA TO GENERATE HISTORICAL FINANCIAL TRANSACTION DATA SEGMENT DATA REPRESENTING IDENTIFIED HISTORICAL FINANCIAL TRANSACTION DATA SEGMENTS OPERATION 209 the financial transaction data segmentation rules data dictates that the two or more words or symbols are adjacent to one another within the historical financial transaction data. In one embodiment, the financial transaction data segmentation rules data dictates that the two or more words or symbols are within a defined number of words or symbols with respect to each other within the historical financial transaction data.

In various embodiments, at PROCESS THE HISTORICAL FINANCIAL TRANSACTION DATA TO GENERATE HISTORICAL FINANCIAL TRANSACTION DATA SEGMENT DATA REPRESENTING IDENTIFIED HISTORICAL FINANCIAL TRANSACTION DATA SEGMENTS OPERATION 209 the financial transaction data segmentation rules data dictates any segmentation and/or processing rules discussed herein, and/or as known in the art at the time of filing, and/or as developed after the time of filing.

In one embodiment, once the historical financial transaction data is segmented at PROCESS THE HISTORICAL FINANCIAL TRANSACTION DATA TO GENERATE HISTORICAL FINANCIAL TRANSACTION DATA SEGMENT DATA REPRESENTING IDENTIFIED HISTORICAL FINANCIAL TRANSACTION DATA SEGMENTS OPERATION 209, process flow proceeds to FOR AT LEAST ONE IDENTIFIED HISTORICAL FINANCIAL TRANSACTION DATA SEGMENT GENERATE CORRELATED HISTORICAL FINANCIAL TRANSACTION DATA SEGMENT DATA AND HISTORICAL FINANCIAL TRANSACTION CATEGORY DATA OPERATION 211.

In one embodiment, at FOR AT LEAST ONE IDENTIFIED HISTORICAL FINANCIAL TRANSACTION DATA SEGMENT GENERATE CORRELATED HISTORICAL FINANCIAL TRANSACTION DATA SEGMENT DATA AND HISTORICAL FINANCIAL TRANSACTION CATEGORY DATA OPERATION 211, for at least one identified historical financial transaction data segment represented by historical financial transaction data segment data, historical financial transaction category data representing the historical financial transaction category assigned to the historical financial transaction represented in the historical financial transaction data including the historical financial transaction data segment is obtained.

In one embodiment, the historical financial transaction category data for at least one identified historical financial transaction data segment of FOR AT LEAST ONE IDENTIFIED HISTORICAL FINANCIAL TRANSACTION DATA SEGMENT GENERATE CORRELATED HISTORICAL FINANCIAL TRANSACTION DATA SEGMENT DATA AND HISTORICAL FINANCIAL TRANSACTION CATEGORY DATA OPERATION 211 includes data indicating historical financial transaction categories applied to the financial transaction data including the historical financial transaction data segment by one or more parties and/or the current user of the financial management system.

In one embodiment, the historical financial transaction category data for at least one identified historical financial transaction data segment of FOR AT LEAST ONE IDENTIFIED HISTORICAL FINANCIAL TRANSACTION DATA SEGMENT GENERATE CORRELATED HISTORICAL FINANCIAL TRANSACTION DATA SEGMENT DATA AND HISTORICAL FINANCIAL TRANSACTION CATEGORY DATA OPERATION 211 includes categorization data manually entered by the one or more parties and/or the current user of the financial management system.

In one embodiment, the historical financial transaction category data for at least one identified historical financial transaction data segment of FOR AT LEAST ONE IDENTIFIED HISTORICAL FINANCIAL TRANSACTION DATA SEGMENT GENERATE CORRELATED HISTORICAL FINANCIAL TRANSACTION DATA SEGMENT DATA AND HISTORICAL FINANCIAL TRANSACTION CATEGORY DATA OPERATION 211 includes categorization data in the form of approval data associated with automatic categorizations entered by the one or more parties and/or the current user of the financial management system.

In one embodiment, the historical financial transaction category data for at least one identified historical financial transaction data segment of FOR AT LEAST ONE IDENTIFIED HISTORICAL FINANCIAL TRANSACTION DATA SEGMENT GENERATE CORRELATED HISTORICAL FINANCIAL TRANSACTION DATA SEGMENT DATA AND HISTORICAL FINANCIAL TRANSACTION CATEGORY DATA OPERATION 211 includes data indicating a number of historical financial transactions that include the current financial transaction data segment.

In one embodiment, the historical financial transaction category data for at least one identified historical financial transaction data segment of FOR AT LEAST ONE IDENTIFIED HISTORICAL FINANCIAL TRANSACTION DATA SEGMENT GENERATE CORRELATED HISTORICAL FINANCIAL TRANSACTION DATA SEGMENT DATA AND HISTORICAL FINANCIAL TRANSACTION CATEGORY DATA OPERATION 211 includes data indicating the number of unique parties associated with the determined number of historical financial transactions that include the current financial transaction data segment.

In one embodiment, the historical financial transaction category data for at least one identified historical financial transaction data segment of FOR AT LEAST ONE IDENTIFIED HISTORICAL FINANCIAL TRANSACTION DATA SEGMENT GENERATE CORRELATED HISTORICAL FINANCIAL TRANSACTION DATA SEGMENT DATA AND HISTORICAL FINANCIAL TRANSACTION CATEGORY DATA OPERATION 211 includes data indicating the number of the historical financial transactions that include the current financial transaction data segment that were categorized as being of the first financial transaction category, or any other financial transaction category of interest.

In one embodiment, the historical financial transaction category data for at least one identified historical financial transaction data segment of FOR AT LEAST ONE IDENTIFIED HISTORICAL FINANCIAL TRANSACTION DATA SEGMENT GENERATE CORRELATED HISTORICAL FINANCIAL TRANSACTION DATA SEGMENT DATA AND HISTORICAL FINANCIAL TRANSACTION CATEGORY DATA OPERATION 211 includes any data desired and/or as discussed herein, and/or as known in the art at the time of filing, and/or as developed after the time of filing.

In accordance with one embodiment, for at least one identified historical financial transaction data segment represented by historical financial transaction data segment data, the historical financial transaction data segment data representing that historical financial transaction data segment is correlated to historical financial transaction category data representing the historical financial transaction category assigned to the historical financial transaction represented in the historical financial transaction data including the historical financial transaction data segment at FOR AT LEAST ONE IDENTIFIED HISTORICAL FINANCIAL TRANSACTION DATA SEGMENT GENERATE CORRELATED HISTORICAL FINANCIAL TRANSACTION DATA SEGMENT DATA AND HISTORICAL FINANCIAL TRANSACTION CATEGORY DATA OPERATION 211. In this way, correlated historical financial transaction data segment data and historical financial transaction category data is generated at FOR AT LEAST ONE IDENTIFIED HISTORICAL FINANCIAL TRANSACTION DATA SEGMENT GENERATE CORRELATED HISTORICAL FINANCIAL TRANSACTION DATA SEGMENT DATA AND HISTORICAL FINANCIAL TRANSACTION CATEGORY DATA OPERATION 211.

In one embodiment, once historical financial transaction category data representing the historical financial transaction category assigned to the historical financial transaction represented in the historical financial transaction data including the historical financial transaction data segment is obtained at FOR AT LEAST ONE IDENTIFIED HISTORICAL FINANCIAL TRANSACTION DATA SEGMENT GENERATE CORRELATED HISTORICAL FINANCIAL TRANSACTION DATA SEGMENT DATA AND HISTORICAL FINANCIAL TRANSACTION CATEGORY DATA OPERATION 211, process flow proceeds to OBTAIN CURRENT FINANCIAL TRANSACTION DATA REPRESENTING A FINANCIAL TRANSACTION ASSOCIATED WITH A USER OPERATION 213.

In one embodiment, at OBTAIN CURRENT FINANCIAL TRANSACTION DATA REPRESENTING A FINANCIAL TRANSACTION ASSOCIATED WITH A USER OPERATION 213, current financial transaction data representing a financial transaction associated with a user is obtained.

In one embodiment, the historical financial transaction data is obtained at OBTAIN CURRENT FINANCIAL TRANSACTION DATA REPRESENTING A FINANCIAL TRANSACTION ASSOCIATED WITH A USER OPERATION 213 from one or more financial management systems and/or other financial transaction data sources, such as any of the financial management systems and/or other financial transaction data sources discussed herein, and/or as known in the art at the time of filing, and/or as developed after the time of filing, and/or by any means as discussed herein, and/or as known in the art at the time of filing, and/or as becomes known after the time of filing.

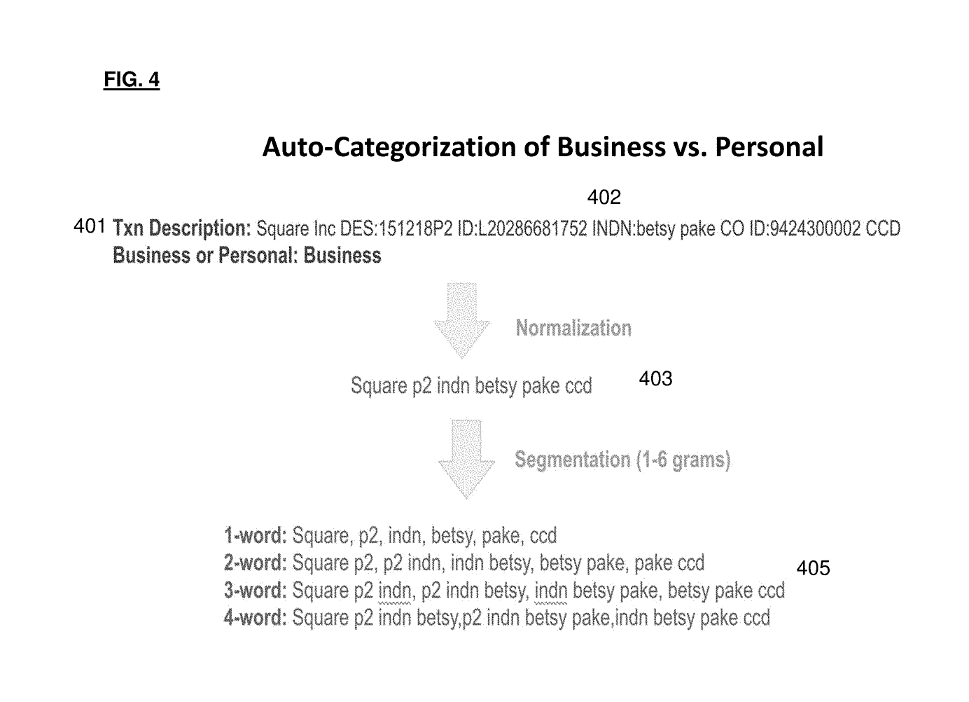

FIG. 4 is a high level flow diagram showing examples of the normalization and segmentation of financial transaction data in accordance with one embodiment.

As seen in FIG. 4, in this specific illustrative example, current financial transaction data 401 representing a financial transaction associated with a user includes text and symbols 402.

Returning to FIG. 2, in one embodiment, once current financial transaction data representing a financial transaction associated with a user is obtained at OBTAIN CURRENT FINANCIAL TRANSACTION DATA REPRESENTING A FINANCIAL TRANSACTION ASSOCIATED WITH A USER OPERATION 213, process flow proceeds to NORMALIZE THE CURRENT FINANCIAL TRANSACTION DATA OPERATION 215.

In one embodiment, at NORMALIZE THE CURRENT FINANCIAL TRANSACTION DATA OPERATION 215, the obtained current financial transaction data is normalized to generate normalized current financial transaction data.

In various embodiments, at NORMALIZE THE CURRENT FINANCIAL TRANSACTION DATA OPERATION 215 the obtained current financial transaction data is normalized to remove irrelevant text and symbols from the current financial transaction data in accordance with one or more normalization rules represented by normalization rules data.

Returning to FIG. 4, as noted, FIG. 4 is a high level flow diagram showing examples of the normalization and segmentation of financial transaction data in accordance with one embodiment.

As seen in FIG. 4, in this specific illustrative example, current financial transaction data 401 representing a financial transaction associated with a user including text and symbols 402 is normalized down to normalized current financial transaction data 403.

Returning to FIG. 2, in one embodiment, once the obtained current financial transaction data is normalized to generate normalized current financial transaction data at NORMALIZE THE CURRENT FINANCIAL TRANSACTION DATA OPERATION 215, process flow proceeds to PROCESS THE NORMALIZED CURRENT FINANCIAL TRANSACTION DATA TO GENERATE CURRENT FINANCIAL TRANSACTION DATA SEGMENT DATA OPERATION 217.

In one embodiment, at PROCESS THE NORMALIZED CURRENT FINANCIAL TRANSACTION DATA TO GENERATE CURRENT FINANCIAL TRANSACTION DATA SEGMENT DATA OPERATION 217, the normalized current financial transaction data of NORMALIZE THE CURRENT FINANCIAL TRANSACTION DATA OPERATION 215 is subjected to an initial processing whereby the normalized current financial transaction data is segmented.

In one embodiment, at PROCESS THE NORMALIZED CURRENT FINANCIAL TRANSACTION DATA TO GENERATE CURRENT FINANCIAL TRANSACTION DATA SEGMENT DATA OPERATION 217 the normalized current financial transaction data is subjected to an initial processing whereby the normalized current financial transaction data is analyzed with the same, or similar, financial transaction data segmentation rules data applied to the historical financial transaction data discussed above.

In one embodiment, one or more current financial transaction data segments are thereby identified at PROCESS THE NORMALIZED CURRENT FINANCIAL TRANSACTION DATA TO GENERATE CURRENT FINANCIAL TRANSACTION DATA SEGMENT DATA OPERATION 217 and represented by current financial transaction data segment data.

In one embodiment, the financial transaction data segmentation rules data of PROCESS THE NORMALIZED CURRENT FINANCIAL TRANSACTION DATA TO GENERATE CURRENT FINANCIAL TRANSACTION DATA SEGMENT DATA OPERATION 217 dictates that the identified current financial transaction data segments represented by the current financial transaction data segment data include a word or symbol in the current financial transaction data segment.

In one embodiment, the financial transaction data segmentation rules data of PROCESS THE NORMALIZED CURRENT FINANCIAL TRANSACTION DATA TO GENERATE CURRENT FINANCIAL TRANSACTION DATA SEGMENT DATA OPERATION 217 dictates that the identified current financial transaction data segments represented by the current financial transaction data segment data include two or more words or symbols.

In one embodiment, the financial transaction data segmentation rules data of PROCESS THE NORMALIZED CURRENT FINANCIAL TRANSACTION DATA TO GENERATE CURRENT FINANCIAL TRANSACTION DATA SEGMENT DATA OPERATION 217 dictates that the two or more words or symbols are adjacent to one another within the current financial transaction data.

In one embodiment, the financial transaction data segmentation rules data of PROCESS THE NORMALIZED CURRENT FINANCIAL TRANSACTION DATA TO GENERATE CURRENT FINANCIAL TRANSACTION DATA SEGMENT DATA OPERATION 217 dictates that the two or more words or symbols are within a defined number of words or symbols with respect to each other within the current financial transaction data.

In various embodiments, the financial transaction data segmentation rules data of PROCESS THE NORMALIZED CURRENT FINANCIAL TRANSACTION DATA TO GENERATE CURRENT FINANCIAL TRANSACTION DATA SEGMENT DATA OPERATION 217 dictates any segmentation and/or processing rules discussed herein, and/or as known in the art at the time of filing, and/or as developed after the time of filing.

Returning to FIG. 4, as noted, FIG. 4 is a high level flow diagram showing examples of the normalization and segmentation of financial transaction data in accordance with one embodiment.

As seen in FIG. 4, in this specific illustrative example normalized current financial transaction data 403 is processed and segmented into data segments 405.

Returning to FIG. 2, in one embodiment, once the normalized current financial transaction data is subjected to an initial processing whereby the normalized current financial transaction data is segmented at PROCESS THE NORMALIZED CURRENT FINANCIAL TRANSACTION DATA TO GENERATE CURRENT FINANCIAL TRANSACTION DATA SEGMENT DATA OPERATION 217, process flow proceeds to FOR AT LEAST ONE IDENTIFIED CURRENT FINANCIAL TRANSACTION DATA SEGMENT DETERMINE A CURRENT FINANCIAL TRANSACTION DATA SEGMENT SCORE OPERATION 219.

In one embodiment, at FOR AT LEAST ONE IDENTIFIED CURRENT FINANCIAL TRANSACTION DATA SEGMENT DETERMINE A CURRENT FINANCIAL TRANSACTION DATA SEGMENT SCORE OPERATION 219, for at least one identified current financial transaction data segment represented by current financial transaction data segment data, the correlated historical financial transaction data segment data and historical financial transaction category data for that current financial transaction data segment is obtained and analyzed to determine a current financial transaction data segment score.

In one embodiment, at FOR AT LEAST ONE IDENTIFIED CURRENT FINANCIAL TRANSACTION DATA SEGMENT DETERMINE A CURRENT FINANCIAL TRANSACTION DATA SEGMENT SCORE OPERATION 219 for at least one identified current financial transaction data segment represented by current financial transaction data segment data, current financial transaction data segment score data is generated representing the determined current financial transaction data segment score associated with the current financial transaction data segment data.

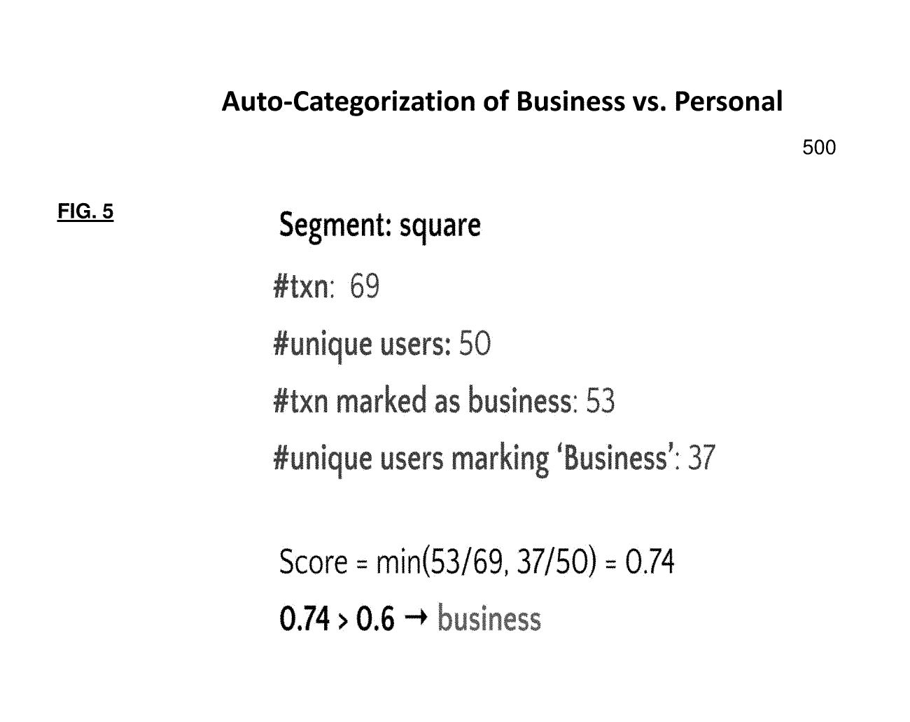

As a specific illustrative example of a method for determining a current financial transaction data segment score in accordance with one embodiment, FIG. 5 is a high level diagram of an illustrative example of one embodiment of an average score based determination of a current financial transaction data segment score method 500.

As seen in FIG. 5, in one embodiment, a current financial transaction data segment score to be associated with at least one identified current financial transaction data segment is determined by using the correlated historical financial transaction data segment data and historical financial transaction category data for that current financial transaction data segment to:
a. Determine a number of historical financial transactions that include the current financial transaction data segment, e.g., #txn in FIG. 5 (69 in this specific example);
b. Determine the number of unique, i.e., different, parties associated with the determined number of historical financial transactions that include the current financial transaction data segment, e.g., #unique users in FIG. 5 (50 in this specific example);
c. Determine the number of the historical financial transactions that include the current financial transaction data segment that were categorized as being of the first financial transaction category, e.g., #txn marked as business in FIG. 5 (53 in this specific example);
d. Determine the number of unique parties that categorized the historical financial transactions that include the current financial transaction data segment as being of the first financial transaction category, e.g., #unique users marking “Business” in FIG. 5 (37 in this specific example);
e. Divide the number of the historical financial transactions that include the current financial transaction data segment that were categorized as being of the first financial transaction category by the number of historical financial transactions that include the current financial transaction data segment (53/69 or 0.77, in this specific example);
f. Divide the number of unique parties that categorized the historical financial transactions that include the current financial transaction data segment as being of the first financial transaction category by the number of unique parties associated with the determined number of historical financial transactions that include the current financial transaction data segment (37/50, or 0.74, in this specific example); and
g. Assign a current financial transaction data segment score to the current financial transaction data segment data that is equal to the value of the number of the historical financial transactions that include the current financial transaction data segment that were categorized as being of the first financial transaction category divided by the number of historical financial transactions that include the current financial transaction data segment (53/69 or 0.77, in this specific example), or the number of unique parties that categorized the historical financial transactions that include the current financial transaction data segment as being of the first financial transaction category divided by the number of unique parties associated with the determined number of historical financial transactions that include the current financial transaction data segment (37/50, or 0.74, in this specific example).

In accordance with one embodiment, the current financial transaction data segment score assigned to current financial transaction data segment data is equal to the lower of the value of:
a. The number of the historical financial transactions that include the current financial transaction data segment that were categorized as being of the first financial transaction category divided by the number of historical financial transactions that include the current financial transaction data segment; or
b. The number of unique parties that categorized the historical financial transactions that include the current financial transaction data segment as being of the first financial transaction category divided by the number of unique parties associated with the determined number of historical financial transactions that include the current financial transaction data segment (53/69 or 0.77, in this specific example).

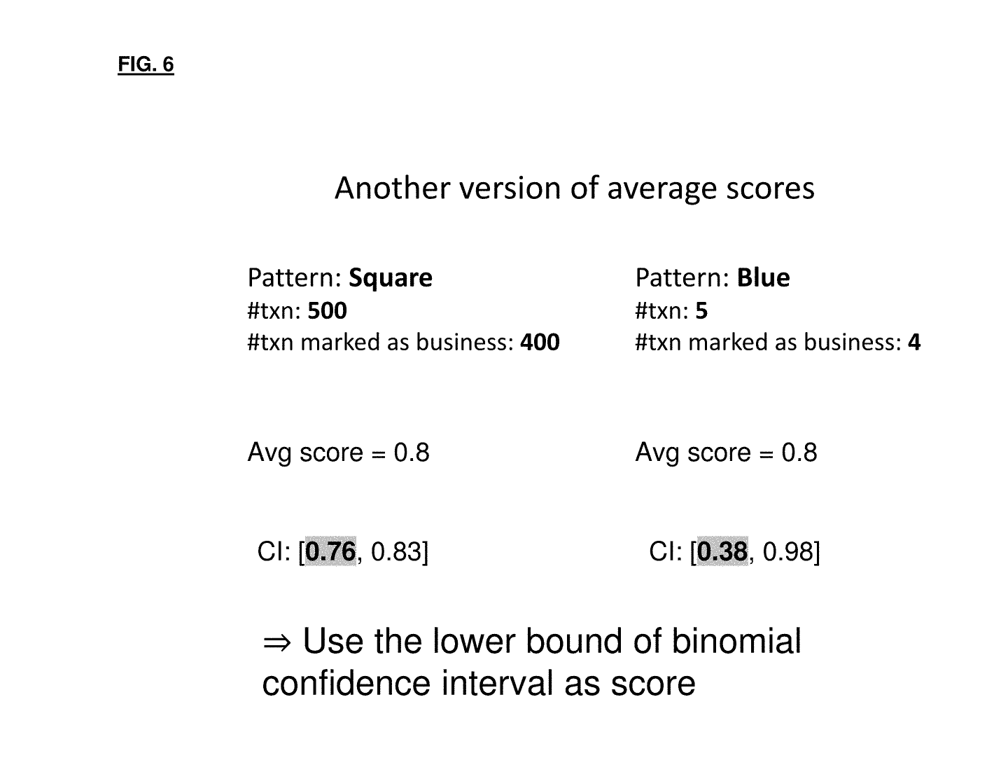

As another specific illustrative example of a method for determining a current financial transaction data segment score in accordance with one embodiment, FIG. 6 is a high level diagram of an illustrative example of one embodiment of a lower bound binomial confidence score based determination of a current financial transaction data segment score.

As seen in FIG. 6, in one embodiment, a current financial transaction data segment score to be associated with at least one identified current financial transaction data segment is determined by using the correlated historical financial transaction data segment data and historical financial transaction category data for that current financial transaction data segment to determine a binomial confidence interval for the current financial transaction data segment and then using the lower bound of the binomial confidence interval for the current financial transaction data segment as the current financial transaction data segment score, in this specific example.

Returning to FIG. 2, in one embodiment, once for at least one identified current financial transaction data segment represented by current financial transaction data segment data, a current financial transaction data segment score is determined at FOR AT LEAST ONE IDENTIFIED CURRENT FINANCIAL TRANSACTION DATA SEGMENT DETERMINE A CURRENT FINANCIAL TRANSACTION DATA SEGMENT SCORE OPERATION 219, process flow proceeds to DEFINE A THRESHOLD FINANCIAL TRANSACTION DATA SEGMENT SCORE OPERATION 220.

In one embodiment, at DEFINE A THRESHOLD FINANCIAL TRANSACTION DATA SEGMENT SCORE OPERATION 220, a threshold financial transaction data segment score is defined.

In one embodiment, at DEFINE A THRESHOLD FINANCIAL TRANSACTION DATA SEGMENT SCORE OPERATION 220, a threshold financial transaction data segment score is defined such that financial transaction data including a financial transaction data segment having a financial transaction data segment score greater than the defined threshold financial transaction data segment score is identified as potential first financial transaction category financial transaction data and financial transaction data including a financial transaction data segment having a financial transaction data segment score not greater than the defined threshold financial transaction data segment score is identified as potential second financial transaction category financial transaction data.

In various embodiments, the threshold financial transaction data segment score is defined differently at DEFINE A THRESHOLD FINANCIAL TRANSACTION DATA SEGMENT SCORE OPERATION 220 based on a balance between several factors. These factors can include, but are not limited to: accuracy, e.g., the model and the truth match up of the eventual financial transaction data categorization desired; prevalence, e.g., the proportion of financial transactions marked as business category financial transactions by the model, associated with the defined threshold financial transaction data segment score; precision, e.g., the proportion of business financial transactions marked by model that are actually business financial transactions of the eventual financial transaction data categorization desired; and the recall, e.g., the proportion of actual business financial transactions that are correctly identified by the model, using the defined threshold financial transaction data segment score.

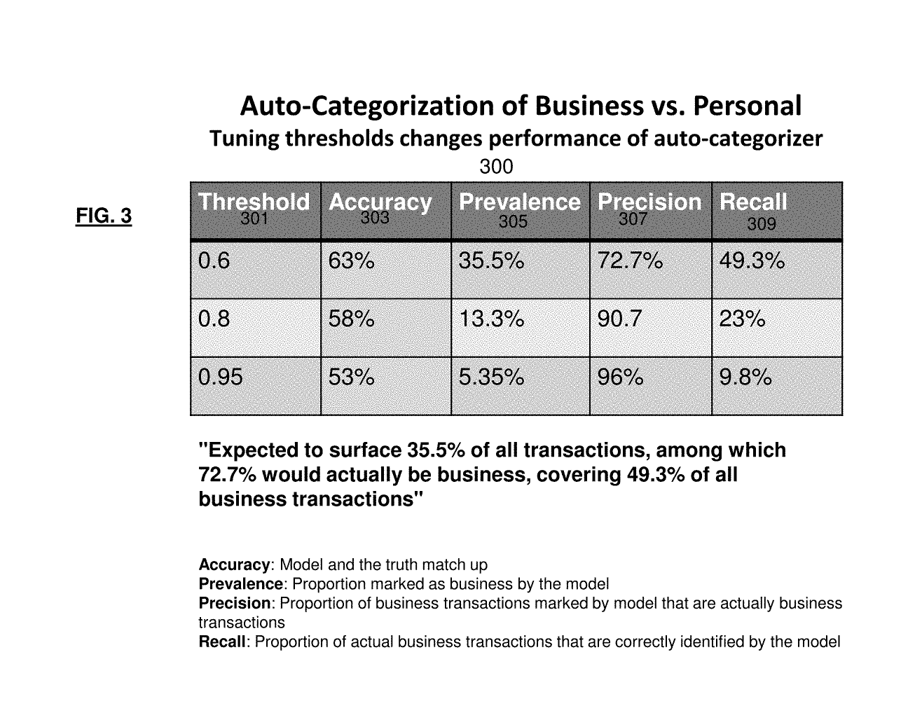

FIG. 3 is a table 300 showing empirical results obtained using different defined threshold financial transaction data segment scores 301 within one embodiment of process 200 for automatically categorizing financial transaction data.

FIG. 3 shows the interaction and effect on the accuracy 303, e.g., the model and the truth match up of the eventual financial transaction data categorization desired; the prevalence 305, e.g., the proportion of financial transactions marked as business category financial transactions by the model, associated with the defined threshold financial transaction data segment score; the precision 307, e.g., the proportion of business financial transactions marked by model that are actually business financial transactions of the eventual financial transaction data categorization desired; and the recall 309, e.g., the proportion of actual business financial transactions that are correctly identified by the model, using the defined threshold financial transaction data segment score.

In one embodiment, once a threshold financial transaction data segment score is defined at DEFINE A THRESHOLD FINANCIAL TRANSACTION DATA SEGMENT SCORE OPERATION 220, process flow proceeds to FOR AT LEAST ONE IDENTIFIED CURRENT FINANCIAL TRANSACTION DATA SEGMENT ANALYZE AND COMPARE THE DETERMINED CURRENT FINANCIAL TRANSACTION DATA SEGMENT SCORE ASSOCIATED WITH THE CURRENT FINANCIAL TRANSACTION DATA SEGMENT AND THE THRESHOLD FINANCIAL TRANSACTION DATA SEGMENT SCORE OPERATION 221.

In one embodiment, at FOR AT LEAST ONE IDENTIFIED CURRENT FINANCIAL TRANSACTION DATA SEGMENT ANALYZE AND COMPARE THE DETERMINED CURRENT FINANCIAL TRANSACTION DATA SEGMENT SCORE ASSOCIATED WITH THE CURRENT FINANCIAL TRANSACTION DATA SEGMENT AND THE THRESHOLD FINANCIAL TRANSACTION DATA SEGMENT SCORE OPERATION 221, for at least one identified current financial transaction data segment represented by current financial transaction data segment data, the determined current financial transaction data segment score data associated with the current financial transaction data segment data and the threshold financial transaction data segment score data representing the defined threshold financial transaction data segment score are analyzed and compared.

In one embodiment, once for at least one identified current financial transaction data segment represented by current financial transaction data segment data, the determined current financial transaction data segment score data associated with the current financial transaction data segment data and the threshold financial transaction data segment score data representing the defined threshold financial transaction data segment score are analyzed and compared at FOR AT LEAST ONE IDENTIFIED CURRENT FINANCIAL TRANSACTION DATA SEGMENT ANALYZE AND COMPARE THE DETERMINED CURRENT FINANCIAL TRANSACTION DATA SEGMENT SCORE ASSOCIATED WITH THE CURRENT FINANCIAL TRANSACTION DATA SEGMENT AND THE THRESHOLD FINANCIAL TRANSACTION DATA SEGMENT SCORE OPERATION 221, process flow proceeds to IF THE DETERMINED CURRENT FINANCIAL TRANSACTION DATA SEGMENT SCORE ASSOCIATED WITH THE CURRENT FINANCIAL TRANSACTION DATA SEGMENT IS GREATER THAN THE DEFINED THRESHOLD FINANCIAL TRANSACTION DATA SEGMENT SCORE, TRANSFORM THE FINANCIAL TRANSACTION CATEGORY ASSIGNED TO THE CURRENT FINANCIAL TRANSACTION DATA TO POTENTIAL FIRST FINANCIAL TRANSACTION CATEGORY FINANCIAL TRANSACTION DATA OPERATION 223.

In one embodiment, at IF THE DETERMINED CURRENT FINANCIAL TRANSACTION DATA SEGMENT SCORE ASSOCIATED WITH THE CURRENT FINANCIAL TRANSACTION DATA SEGMENT IS GREATER THAN THE DEFINED THRESHOLD FINANCIAL TRANSACTION DATA SEGMENT SCORE, TRANSFORM THE FINANCIAL TRANSACTION CATEGORY ASSIGNED TO THE CURRENT FINANCIAL TRANSACTION DATA TO POTENTIAL FIRST FINANCIAL TRANSACTION CATEGORY FINANCIAL TRANSACTION DATA OPERATION 223, if the determined current financial transaction data segment score associated with the current financial transaction data segment data, as represented by the current financial transaction data segment score data, is greater than the defined threshold financial transaction data segment score represented by the threshold financial transaction data segment score data, financial transaction categorization data representing a financial transaction category assigned to the current financial transaction data is transformed into financial transaction categorization data identifying the current financial transaction data as potential first financial transaction category financial transaction data.

In one embodiment, once the financial transaction categorization data representing a financial transaction category assigned to the current financial transaction data is transformed to financial transaction categorization data identifying the current financial transaction data as potential first financial transaction category financial transaction data or potential second financial transaction category financial transaction data, the user is informed of the transformation.

In one embodiment, once the financial transaction categorization data representing a financial transaction category assigned to the current financial transaction data is transformed to financial transaction categorization data identifying the current financial transaction data as potential first financial transaction category financial transaction data or potential second financial transaction category financial transaction data, the user is informed of the transformation and user confirmation and/or approval of the transformation is requested/required.

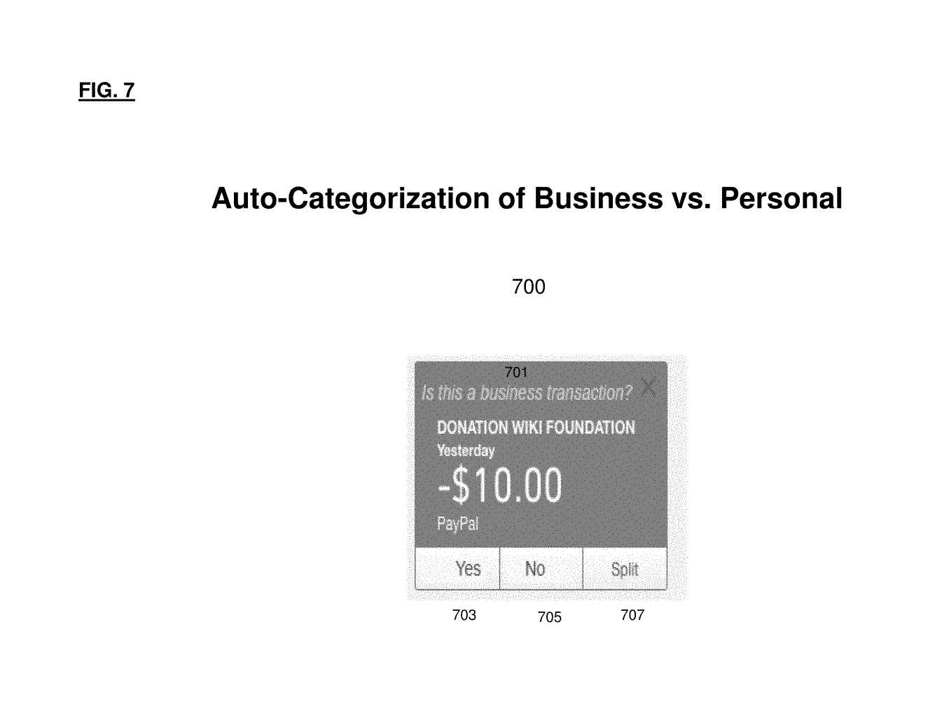

FIG. 7 shows one illustrative example of a user interface display 700 informing the user of a financial transaction data categorization transformation and requesting user confirmation and/or approval of the transformation.

As seen in FIG. 7 user interface display 700 includes data 701 informing the user of a financial transaction data categorization transformation and check boxes 703, 705, and 707, requesting user confirmation and/or approval of the transformation

Returning to FIG. 2, in one embodiment, once financial transaction categorization data representing a financial transaction category assigned to the current financial transaction data is transformed into financial transaction categorization data identifying the current financial transaction data as potential first financial transaction category financial transaction data at IF THE DETERMINED CURRENT FINANCIAL TRANSACTION DATA SEGMENT SCORE ASSOCIATED WITH THE CURRENT FINANCIAL TRANSACTION DATA SEGMENT IS GREATER THAN THE DEFINED THRESHOLD FINANCIAL TRANSACTION DATA SEGMENT SCORE, TRANSFORM THE FINANCIAL TRANSACTION CATEGORY ASSIGNED TO THE CURRENT FINANCIAL TRANSACTION DATA TO POTENTIAL FIRST FINANCIAL TRANSACTION CATEGORY FINANCIAL TRANSACTION DATA OPERATION 223, process flow proceeds to EXIT OPERATION 230.

In one embodiment, at EXIT OPERATION 230 process 200 for automatically categorizing financial transaction data is exited to await new data.

Process 200 for automatically categorizing financial transaction data, provides an efficient, effective, and dynamically adaptable technical solution to the long standing technical problem in the financial transaction data management, data processing, and user experience arts of providing accurate categorization of financial transaction data that is relatively simple, leverages financial transaction categorization data from other parties, is largely automatic, and is accurate without being overly burdensome on the user, the financial management system, and/or data processing systems.

As a specific illustrative example, when the process 200 for automatically categorizing financial transaction data is implemented with a financial management system designed to help a self-employed user track their expenses, prepare their taxes, and/or manage their income needs, the defined first and second financial transaction categories can be business expenses and personal expenses. Consequently, process 200 for automatically categorizing financial transaction data provides the financial management system the ability to categorize financial transaction data representing various financial transactions conducted by, or on behalf of the user, as either business expenses, i.e., those in Form 1040 schedule C categories, or personal expenses in an efficient, automatic, and accurate manner.

As an even more specific illustrative example, when process 200 for automatically categorizing financial transaction data is used with a financial management system designed to help a self-employed user track their expenses, prepare their taxes, and/or manage their income needs, the defined first and second financial transaction categories can simply be defined as business expenses and all other expenses. Therefore, more potential business transactions can be identified automatically. This is significant since, as noted above, the more automated the categorization process and the more financial transactions tentatively categorized, reasonably, as business expense transactions, the more the user will value the financial management system and continue to use the financial management system to obtain the most benefit from the financial management system.

However, process 200 for automatically categorizing financial transaction data does not encompass, embody, or preclude other forms of innovation in the area of financial transaction data processing and financial transaction data categorization. In addition, process 200 for automatically categorizing financial transaction data is not related to any fundamental economic practice, fundamental data processing practice, mental steps, or pen and paper based solution. In fact, process 200 for automatically categorizing financial transaction data is directed to providing solutions to the relatively new problems associated with the automatic processing, categorization, and display of electronic financial transaction data obtained from multiple sources and the leveraging, management, and processing of large amounts of data, i.e., “big data.” Consequently, process 200 for automatically categorizing financial transaction data is not directed to, does not encompass, and is not merely, an abstract idea or concept.

In addition, process 200 for automatically categorizing financial transaction data provides for significant improvements to the technical fields of electronic transaction data processing, information dissemination, data processing, data management, data filtering and mining, automatic categorization of data, and user experience.

In addition, implementation of process 200 for automatically categorizing financial transaction data results in more efficient use of human and non-human resources, fewer processor cycles being utilized, reduced memory utilization, and less communications bandwidth being utilized to relay data to, and from, backend systems and client systems.

As a result, computing systems are transformed into faster, more efficient, and more effective computing systems by implementing process 200 for automatically categorizing financial transaction data.

The present invention has been described in particular detail with respect to specific possible embodiments. Those of skill in the art will appreciate that the invention may be practiced in other embodiments. For example, the nomenclature used for components, capitalization of component designations and terms, the attributes, data structures, or any other programming or structural aspect is not significant, mandatory, or limiting, and the mechanisms that implement the invention or its features can have various different names, formats, and/or protocols. Further, the system and/or functionality of the invention may be implemented via various combinations of software and hardware, as described, or entirely in hardware elements. Also, particular divisions of functionality between the various components described herein are merely exemplary, and not mandatory or significant. Consequently, functions performed by a single component may, in other embodiments, be performed by multiple components, and functions performed by multiple components may, in other embodiments, be performed by a single component.

Some portions of the above description present the features of the present invention in terms of algorithms and symbolic representations of operations, or algorithm-like representations, of operations on information/data. These algorithmic and/or algorithm-like descriptions and representations are the means used by those of skill in the art to most effectively and efficiently convey the substance of their work to others of skill in the art. These operations, while described functionally or logically, are understood to be implemented by computer programs and/or computing systems. Furthermore, it has also proven convenient at times to refer to these arrangements of operations as steps or modules or by functional names, without loss of generality.

Unless specifically stated otherwise, as would be apparent from the above discussion, it is appreciated that throughout the above description, discussions utilizing terms such as “defining,” “determining,” “calculating,” “transforming,” “correlating,” “normalizing,” “accessing,” “analyzing,” “obtaining,” “identifying,” “associating,” “aggregating,” “initiating,” “collecting,” “creating,” “transferring,” “storing,” “searching,” “comparing,” “providing,” “processing” etc., refer to the action and processes of a computing system or similar electronic device that manipulates and operates on data represented as physical (electronic) quantities within the computing system memories, resisters, caches or other information storage, transmission or display devices.

Certain aspects of the present invention include process steps or operations and instructions described herein in an algorithmic and/or algorithmic-like form. It should be noted that the process steps and/or operations and instructions of the present invention can be embodied in software, firmware, and/or hardware, and when embodied in software, can be downloaded to reside on and be operated from different platforms used by real time network operating systems.

The present invention also relates to an apparatus or system for performing the operations described herein. This apparatus or system may be specifically constructed for the required purposes by a computer program stored via a computer program product as defined herein that can be accessed by a computing system or other device to transform the computing system or other device into a specifically and specially programmed computing system or other device.

Those of skill in the art will readily recognize that the algorithms and operations presented herein are not inherently related to any particular computing system, computer architecture, computer or industry standard, or any other specific apparatus. It may prove convenient/efficient to construct or transform one or more specialized apparatuses to perform the required operations described herein. The required structure for a variety of these systems will be apparent to those of skill in the art, along with equivalent variations. In addition, the present invention is not described with reference to any particular programming language and it is appreciated that a variety of programming languages may be used to implement the teachings of the present invention as described herein, and any references to a specific language or languages are provided for illustrative purposes only and for enablement of the contemplated best mode of the invention at the time of filing.

The present invention is well suited to a wide variety of computer network systems operating over numerous topologies. Within this field, the configuration and management of large networks comprise storage devices and computers that are communicatively coupled to similar and/or dissimilar computers and storage devices over a private network, a LAN, a WAN, a private network, or a public network, such as the Internet.

It should also be noted that the language used in the specification has been principally selected for readability, clarity, and instructional purposes, and may not have been selected to delineate or circumscribe the inventive subject matter. Accordingly, the disclosure of the present invention is intended to be illustrative, but not limiting, of the scope of the invention, which is set forth in the claims below.

In addition, the operations shown in the FIG.s are identified using a particular nomenclature for ease of description and understanding, but other nomenclature is often used in the art to identify equivalent operations.

In the discussion above, certain aspects of one embodiment include process steps and/or operations and/or instructions described herein for illustrative purposes in a particular order and/or grouping. However, the particular order and/or grouping shown and discussed herein is illustrative only and not limiting. Those of skill in the art will recognize that other orders and/or grouping of the process steps and/or operations and/or instructions are possible and, in some embodiments, one or more of the process steps and/or operations and/or instructions discussed above can be combined and/or deleted. In addition, portions of one or more of the process steps and/or operations and/or instructions can be re-grouped as portions of one or more other of the process steps and/or operations and/or instructions discussed herein. Consequently, the particular order and/or grouping of the process steps and/or operations and/or instructions discussed herein does not limit the scope of the invention as claimed below.

Therefore, numerous variations, whether explicitly provided for by the specification or implied by the specification or not, may be implemented by one of skill in the art in view of this disclosure.

What is claimed is:

1. A method for automatically categorizing financial transaction data comprising:
defining a first financial transaction category;
defining a threshold financial transaction data segment score such that financial transaction data including a financial transaction data segment having a financial transaction data segment score greater than the defined threshold financial transaction data segment score is identified as potential first financial transaction category financial transaction data;
generating threshold financial transaction data segment score data representing the defined threshold financial transaction data segment score;
obtaining historical financial transaction data, the historical financial transaction data representing historical financial transactions conducted by one or more parties, the historical financial transaction data including historical financial transaction categorization data indicating a financial transaction category assigned to the historical financial transactions represented in the historical financial transaction data;
processing the historical financial transaction data to generate historical financial transaction data segment data, the historical financial transaction data segment data representing identified historical financial transaction data segments;
for at least one identified historical financial transaction data segment represented by historical financial transaction data segment data, correlating the historical financial transaction data segment data representing that historical financial transaction data segment to historical financial transaction category data representing the historical financial transaction category assigned to the historical financial transaction represented in the historical financial transaction data including the historical financial transaction data segment to generate correlated historical financial transaction data segment data and historical financial transaction category data;
obtaining current financial transaction data representing a financial transaction associated with a user;
normalizing the current financial transaction data to generate normalized current financial transaction data;
processing the normalized current financial transaction data to generate current financial transaction data segment data, the current financial transaction data segment data representing identified current financial transaction data segments;
for at least one identified current financial transaction data segment represented by current financial transaction data segment data, obtaining the correlated historical financial transaction data segment data and historical financial transaction category data for that current financial transaction data segment to determine a current financial transaction data segment score;
for at least one identified current financial transaction data segment represented by current financial transaction data segment data, generating current financial transaction data segment score data representing the determined current financial transaction data segment score associated with the current financial transaction data segment data;
for at least one identified current financial transaction data segment represented by current financial transaction data segment data, analyzing and comparing the determined current financial transaction data segment score data associated with the current financial transaction data segment data and the threshold financial transaction data segment score data representing the defined threshold financial transaction data segment score; and
if the determined current financial transaction data segment score associated with the current financial transaction data segment data as represented by the current financial transaction data segment score data is greater than the defined threshold financial transaction data segment score represented by the threshold financial transaction data segment score data, transforming financial transaction categorization data representing a financial transaction category assigned to the current financial transaction data to financial transaction categorization data identifying the current financial transaction data as potential first financial transaction category financial transaction data.

2. The method for automatically categorizing financial transaction data of claim 1 wherein the first financial transaction category is selected from the group of first financial transaction categories consisting of;
a business expense financial transaction category;
a personal financial transaction category;
a discretionary financial transaction category; and
a non-discretionary financial transaction category.

3. The method for automatically categorizing financial transaction data of claim 1 wherein the historical financial transaction data representing historical financial transactions conducted by one or more parties is obtained from a financial management system selected from the group of financial management systems consisting of:
a computing system implemented financial management system;
a network accessed financial management system;
a web-based financial management system; and
a cloud-based financial management system.

4. The method for automatically categorizing financial transaction data of claim 1 wherein the current financial transaction data representing a financial transaction associated with a user is obtained from a financial management system selected from the group of financial management systems consisting of:
a computing system implemented financial management system;
a network accessed financial management system;
a web-based financial management system; and
a cloud-based financial management system.

5. The method for automatically categorizing financial transaction data of claim 1 wherein the identified historical financial transaction data segments represented by the historical financial transaction data segment data and/or the current financial transaction data segments represented by the current financial transaction data segment data include a word or symbol in the historical financial transaction data segment.

6. The method for automatically categorizing financial transaction data of claim 1 wherein the identified historical financial transaction data segments represented by the historical financial transaction data segment data and/or the current financial transaction data segments represented by the current financial transaction data segment data include two or more words or symbols.

7. The method for automatically categorizing financial transaction data of claim 6 wherein the two or more words or symbols are adjacent to one another within the historical financial transaction data and/or current financial transaction data.

8. The method for automatically categorizing financial transaction data of claim 6 wherein the two or more words or symbols are within a defined number of words or symbols with respect to each other within the historical financial transaction data and/or the current financial transaction data.

9. The method for automatically categorizing financial transaction data of claim 1 wherein determining a current financial transaction data segment score for at least one identified current financial transaction data segment represented by current financial transaction data segment data comprises:
determining a number of historical financial transactions that include the current financial transaction data segment;
determining the number of unique parties associated with the determined number of historical financial transactions that include the current financial transaction data segment;
determining the number of the historical financial transactions that include the current financial transaction data segment that were categorized as being of the first financial transaction category;
determining the number of unique parties that categorized the historical financial transactions that include the current financial transaction data segment as being of the first financial transaction category;
dividing the number of the historical financial transactions that include the current financial transaction data segment that were categorized as being of the first financial transaction category by the number of historical financial transactions that include the current financial transaction data segment;
dividing the number of unique parties that categorized the historical financial transactions that include the current financial transaction data segment as being of the first financial transaction category by the number of unique parties associated with the determined number of historical financial transactions that include the current financial transaction data segment; and
assigning a current financial transaction data segment score to the current financial transaction data segment data that is equal to the value of the number of the historical financial transactions that include the current financial transaction data segment that were categorized as being of the first financial transaction category divided by the number of historical financial transactions that include the current financial transaction data segment or the number of unique parties that categorized the historical financial transactions that include the current financial transaction data segment as being of the first financial transaction category divided by the number of unique parties associated with the determined number of historical financial transactions that include the current financial transaction data segment.

10. The method for automatically categorizing financial transaction data of claim 9 wherein the current financial transaction data segment score assigned to current financial transaction data segment data is equal to the lower of the value of;
the number of the historical financial transactions that include the current financial transaction data segment that were categorized as being of the first financial transaction category divided by the number of historical financial transactions that include the current financial transaction data segment; or
the number of unique parties that categorized the historical financial transactions that include the current financial transaction data segment as being of the first financial transaction category divided by the number of unique parties associated with the determined number of historical financial transactions that include the current financial transaction data segment.

11. The method for automatically categorizing financial transaction data of claim 1 wherein determining a current financial transaction data segment score for at least one identified current financial transaction data segment represented by current financial transaction data segment data comprises:
determining a binomial confidence interval for the current financial transaction data segment; and
using the lower bound of the binomial confidence interval for the current financial transaction data segment as the current financial transaction data segment score.

12. The method for automatically categorizing financial transaction data of claim 1 further comprising;
once the financial transaction categorization data representing a financial transaction category assigned to the current financial transaction data is transformed to financial transaction categorization data identifying the current financial transaction data as potential first financial transaction category financial transaction data, informing the user of the transformation.

13. The method for automatically categorizing financial transaction data of claim 1 further comprising;
once the financial transaction categorization data representing a financial transaction category assigned to the current financial transaction data is transformed to financial transaction categorization data identifying the current financial transaction data as potential first financial transaction category financial transaction data, informing the user of the transformation and requesting user confirmation and/or approval of the transformation.

14. A method for automatically categorizing financial transaction data comprising:
defining first and second financial transaction categories;
defining a threshold financial transaction data segment score such that financial transaction data including a financial transaction data segment having a category financial transaction data and financial transaction data including a financial transaction data segment score greater than the defined threshold financial transaction data segment score is identified as potential first financial transaction data segment having a financial transaction data segment score not greater than the defined threshold financial transaction data segment score is identified as potential second financial transaction category financial transaction data;
generating threshold financial transaction data segment score data representing the defined threshold financial transaction data segment score;
obtaining historical financial transaction data, the historical financial transaction data representing historical financial transactions conducted by one or more parties, the historical financial transaction data including historical financial transaction categorization data indicating a financial transaction category assigned to the historical financial transactions represented in the historical financial transaction data;
processing the historical financial transaction data to generate historical financial transaction data segment data, the historical financial transaction data segment data representing identified historical financial transaction data segments;
for at least one identified historical financial transaction data segment represented by historical financial transaction data segment data, correlating the historical financial transaction data segment data representing that historical financial transaction data segment to historical financial transaction category data representing the historical financial transaction category assigned to the historical financial transaction represented in the historical financial transaction data including the historical financial transaction data segment to generate correlated historical financial transaction data segment data and historical financial transaction category data;
obtaining current financial transaction data representing a financial transaction associated with a user;
normalizing the current financial transaction data to generate normalized current financial transaction data;
processing the normalized current financial transaction data to generate current financial transaction data segment data, the current financial transaction data segment data representing identified current financial transaction data segments;
for at least one identified current financial transaction data segment represented by current financial transaction data segment data, obtaining the correlated historical financial transaction data segment data and historical financial transaction category data for that current financial transaction data segment to determine a current financial transaction data segment score;
for at least one identified current financial transaction data segment represented by current financial transaction data segment data, generating current financial transaction data segment score data representing the determined current financial transaction data segment score associated with the current financial transaction data segment data;
for at least one identified current financial transaction data segment represented by current financial transaction data segment data, analyzing and comparing the determined current financial transaction data segment score data associated with the current financial transaction data segment data and the threshold financial transaction data segment score data representing the defined threshold financial transaction data segment score; and
if the determined current financial transaction data segment score associated with the current financial transaction data segment data as represented by the current financial transaction data segment score data is greater than the defined threshold financial transaction data segment score represented by the threshold financial transaction data segment score data, transforming financial transaction categorization data representing a financial transaction category assigned to the current financial transaction data to financial transaction categorization data identifying the current financial transaction data as potential first financial transaction category financial transaction data.

15. The method for automatically categorizing financial transaction data of claim 14 wherein the first and second financial transaction categories are selected from the group of first and second financial transaction category pairs consisting of;
a personal and business expense financial transaction category pair;
a personal and business travel financial transaction category pair;
a discretionary and non-discretionary financial transaction category pair.

16. The method for automatically categorizing financial transaction data of claim 14 wherein the historical financial transaction data representing historical financial transactions conducted by one or more parties is obtained from a financial management system selected from the group of financial management systems consisting of:
a computing system implemented financial management system;
a network accessed financial management system;
a web-based financial management system; and
a cloud-based financial management system.

17. The method for automatically categorizing financial transaction data of claim 14 wherein the current financial transaction data representing a financial transaction associated with a user is obtained from a financial management system selected from the group of financial management systems consisting of:
a computing system implemented financial management system;
a network accessed financial management system;
a web-based financial management system; and
a cloud-based financial management system.

18. The method for automatically categorizing financial transaction data of claim 14 wherein the identified historical financial transaction data segments represented by the historical financial transaction data segment data and/or the current financial transaction data segments represented by the current financial transaction data segment data include a word or symbol in the historical financial transaction data segment.

19. The method for automatically categorizing financial transaction data of claim 14 wherein the identified historical financial transaction data segments represented by the historical financial transaction data segment data and/or the current financial transaction data segments represented by the current financial transaction data segment data include two or more words or symbols.

20. The method for automatically categorizing financial transaction data of claim 19 wherein the two or more words or symbols are adjacent to one another within the historical financial transaction data and/or current financial transaction data.

21. The method for automatically categorizing financial transaction data of claim 19 wherein the two or more words or symbols are within a defined number of words or symbols with respect to each other within the historical financial transaction data and/or the current financial transaction data.

22. The method for automatically categorizing financial transaction data of claim 14 wherein determining a current financial transaction data segment score for at least one identified current financial transaction data segment represented by current financial transaction data segment data comprises:
determining a number of historical financial transactions that include the current financial transaction data segment;
determining the number of unique parties associated with the determined number of historical financial transactions that include the current financial transaction data segment;
determining the number of the historical financial transactions that include the current financial transaction data segment that were categorized as being of the first financial transaction category;
determining the number of unique parties that categorized the historical financial transactions that include the current financial transaction data segment as being of the first financial transaction category;
dividing the number of the historical financial transactions that include the current financial transaction data segment that were categorized as being of the first financial transaction category by the number of historical financial transactions that include the current financial transaction data segment;
dividing the number of unique parties that categorized the historical financial transactions that include the current financial transaction data segment as being of the first financial transaction category by the number of unique parties associated with the determined number of historical financial transactions that include the current financial transaction data segment; and
assigning a current financial transaction data segment score to the current financial transaction data segment data that is equal to the value of the number of the historical financial transactions that include the current financial transaction data segment that were categorized as being of the first financial transaction category divided by the number of historical financial transactions that include the current financial transaction data segment or the number of unique parties that categorized the historical financial transactions that include the current financial transaction data segment as being of the first financial transaction category divided by the number of unique parties associated with the determined number of historical financial transactions that include the current financial transaction data segment.

23. The method for automatically categorizing financial transaction data of claim 22 wherein the current financial transaction data segment score assigned to current financial transaction data segment data is equal to the lower of the value of;
the number of the historical financial transactions that include the current financial transaction data segment that were categorized as being of the first financial transaction category divided by the number of historical financial transactions that include the current financial transaction data segment; or
the number of unique parties that categorized the historical financial transactions that include the current financial transaction data segment as being of the first financial transaction category divided by the number of unique parties associated with the determined number of historical financial transactions that include the current financial transaction data segment.

24. The method for automatically categorizing financial transaction data of claim 14 wherein determining a current financial transaction data segment score for at least one identified current financial transaction data segment represented by current financial transaction data segment data comprises:
determining a binomial confidence interval for the current financial transaction data segment; and
using the lower bound of the binomial confidence interval for the current financial transaction data segment as the current financial transaction data segment score.

25. The method for automatically categorizing financial transaction data of claim 14 further comprising;
once the financial transaction categorization data representing a financial transaction category assigned to the current financial transaction data is transformed to financial transaction categorization data identifying the current financial transaction data as potential first financial transaction category financial transaction data or potential second financial transaction category financial transaction data, informing the user of the transformation.

26. The method for automatically categorizing financial transaction data of claim 14 further comprising;
once the financial transaction categorization data representing a financial transaction category assigned to the current financial transaction data is transformed to financial transaction categorization data identifying the current financial transaction data as potential first financial transaction category financial transaction data or potential second financial transaction category financial transaction data, informing the user of the transformation and requesting user confirmation and/or approval of the transformation.

27. A method for automatically categorizing financial transaction data comprising:
defining business and personal financial transaction categories;
defining a threshold financial transaction data segment score such that financial transaction data including a financial transaction data segment having a financial transaction data segment score greater than the defined threshold financial transaction data segment score is identified as potential business financial transaction category financial transaction data;
generating threshold financial transaction data segment score data representing the defined threshold financial transaction data segment score;
obtaining historical financial transaction data, the historical financial transaction data representing historical financial transactions conducted by one or more parties, the historical financial transaction data including historical financial transaction categorization data indicating a financial transaction category assigned to the historical financial transactions represented in the historical financial transaction data;
processing the historical financial transaction data to generate historical financial transaction data segment data, the historical financial transaction data segment data representing identified historical financial transaction data segments;
for at least one identified historical financial transaction data segment represented by historical financial transaction data segment data, correlating the historical financial transaction data segment data representing that historical financial transaction data segment to historical financial transaction category data representing the historical financial transaction category assigned to the historical financial transaction represented in the historical financial transaction data including the historical financial transaction data segment to generate correlated historical financial transaction data segment data and historical financial transaction category data;
obtaining current financial transaction data representing a financial transaction associated with a user;
normalizing the current financial transaction data to generate normalized current financial transaction data;
processing the normalized current financial transaction data to generate current financial transaction data segment data, the current financial transaction data segment data representing identified current financial transaction data segments;
for at least one identified current financial transaction data segment represented by current financial transaction data segment data, obtaining the correlated historical financial transaction data segment data and historical financial transaction category data for that current financial transaction data segment to determine a current financial transaction data segment score;
for at least one identified current financial transaction data segment represented by current financial transaction data segment data, generating current financial transaction data segment score data representing the determined current financial transaction data segment score associated with the current financial transaction data segment data;
for at least one identified current financial transaction data segment represented by current financial transaction data segment data, analyzing and comparing the determined current financial transaction data segment score data associated with the current financial transaction data segment data and the threshold financial transaction data segment score data representing the defined threshold financial transaction data segment score; and
if the determined current financial transaction data segment score associated with the current financial transaction data segment data as represented by the current financial transaction data segment score data is greater than the defined threshold financial transaction data segment score represented by the threshold financial transaction data segment score data, transforming financial transaction categorization data representing a financial transaction category assigned to the current financial transaction data to financial transaction categorization data identifying the current financial transaction data as potential business financial transaction category financial transaction data.

28. The method for automatically categorizing financial transaction data of claim 27 wherein the historical financial transaction data representing historical financial transactions conducted by one or more parties is obtained from a financial management system selected from the group of financial management systems consisting of:
a computing system implemented financial management system;
a network accessed financial management system;
a web-based financial management system; and
a cloud-based financial management system.

29. The method for automatically categorizing financial transaction data of claim 27 wherein the current financial transaction data representing a financial transaction associated with a user is obtained from a financial management system selected from the group of financial management systems consisting of:
a computing system implemented financial management system;
a network accessed financial management system;
a web-based financial management system; and
a cloud-based financial management system.

30. The method for automatically categorizing financial transaction data of claim 27 wherein the identified historical financial transaction data segments represented by the historical financial transaction data segment data and/or the current financial transaction data segments represented by the current financial transaction data segment data include a word or symbol in the historical financial transaction data segment.

31. The method for automatically categorizing financial transaction data of claim 27 wherein the identified historical financial transaction data segments represented by the historical financial transaction data segment data and/or the current financial transaction data segments represented by the current financial transaction data segment data include two or more words or symbols.

32. The method for automatically categorizing financial transaction data of claim 31 wherein the two or more words or symbols are adjacent to one another within the historical financial transaction data and/or current financial transaction data.

33. The method for automatically categorizing financial transaction data of claim 31 wherein the two or more words or symbols are within a defined number of words or symbols with respect to each other within the historical financial transaction data and/or the current financial transaction data.

34. The method for automatically categorizing financial transaction data of claim 27 wherein determining a current financial transaction data segment score for at least one identified current financial transaction data segment represented by current financial transaction data segment data comprises:
determining a number of historical financial transactions that include the current financial transaction data segment;
determining the number of unique parties associated with the determined number of historical financial transactions that include the current financial transaction data segment;
determining the number of the historical financial transactions that include the current financial transaction data segment that were categorized as being of the business financial transaction category;
determining the number of unique parties that categorized the historical financial transactions that include the current financial transaction data segment as being of the business financial transaction category;
dividing the number of the historical financial transactions that include the current financial transaction data segment that were categorized as being of the business financial transaction category by the number of historical financial transactions that include the current financial transaction data segment;
dividing the number of unique parties that categorized the historical financial transactions that include the current financial transaction data segment as being of the business financial transaction category by the number of unique parties associated with the determined number of historical financial transactions that include the current financial transaction data segment; and
assigning a current financial transaction data segment score to the current financial transaction data segment data that is equal to the value of the number of the historical financial transactions that include the current financial transaction data segment that were categorized as being of the business financial transaction category divided by the number of historical financial transactions that include the current financial transaction data segment or the number of unique parties that categorized the historical financial transactions that include the current financial transaction data segment as being of the business financial transaction category divided by the number of unique parties associated with the determined number of historical financial transactions that include the current financial transaction data segment.

35. The method for automatically categorizing financial transaction data of claim 34 wherein the current financial transaction data segment score assigned to current financial transaction data segment data is equal to the lower of the value of;
the number of the historical financial transactions that include the current financial transaction data segment that were categorized as being of the business financial transaction category divided by the number of historical financial transactions that include the current financial transaction data segment; or
the number of unique parties that categorized the historical financial transactions that include the current financial transaction data segment as being of the business financial transaction category divided by the number of unique parties associated with the determined number of historical financial transactions that include the current financial transaction data segment.

36. The method for automatically categorizing financial transaction data of claim 27 wherein determining a current financial transaction data segment score for at least one identified current financial transaction data segment represented by current financial transaction data segment data comprises:
determining a binomial confidence interval for the current financial transaction data segment; and
using the lower bound of the binomial confidence interval for the current financial transaction data segment as the current financial transaction data segment score.

37. The method for automatically categorizing financial transaction data of claim 27 further comprising;
once the financial transaction categorization data representing a financial transaction category assigned to the current financial transaction data is transformed to financial transaction categorization data identifying the current financial transaction data as potential business financial transaction category financial transaction data or potential personal financial transaction category financial transaction data, informing the user of the transformation.

38. The method for automatically categorizing financial transaction data of claim 27 further comprising;
once the financial transaction categorization data representing a financial transaction category assigned to the current financial transaction data is transformed to financial transaction categorization data identifying the current financial transaction data as potential business financial transaction category financial transaction data or potential personal financial transaction category financial transaction data, informing the user of the transformation and requesting user confirmation and/or approval of the transformation.
